(19) United States
(12) Patent Application Publication
(10) Pub. No.: US 2024/0091733 A1
(43) Pub. Date: Mar. 21, 2024

(54) SYSTEM OF MODULAR KITS TO PRODUCE CHEMICAL TARGETS OF INTEREST

(71) Applicant: ODH IP Corp., NEW YORK, NY (US)

(72) Inventors: Eugene Choi, Rockville, MD (US); Kersten Rapp, Rockville, MD (US); Greg Hammersmith, Rockville, MD (US); Brian Cregger, Rockville, MD (US)

(73) Assignee: ODH IP Corp., NEW YORK, NY (US)

(21) Appl. No.: 18/461,222

(22) Filed: Sep. 5, 2023

Related U.S. Application Data
(60) Provisional application No. 63/374,484, filed on Sep. 2, 2022.

(51) Int. Cl. B01J 19/18

(52) U.S. Cl. CPC B01J 19/18; B01J 2219/00049; B01J 2219/00306

(57) ABSTRACT

This disclosure provides systems and methods for the on-demand synthesis, separation, purification and formulation of chemicals, and particularly for the on-demand production of pharmaceutical products. More particularly, the disclosure provides continuous-flow on-demand systems, comprising one or more reagent holding/dispensing containers, continuous-flow chemical synthesis modules and/or one or more separation, crystallization, filtration, wash and/or formulation modules, additionally comprising automated detection systems and methods for monitoring reagents, products and processing parameters and automated control systems and methods for controlling processing conditions and parameters.

### CROSS-REFERENCE TO RELATED APPLICATIONS

This application claims priority from Provisional Application No. 63/374,484, filed Sep. 2, 2022, the entire contents of which are hereby incorporated by reference.

### GOVERNMENTAL RIGHTS

This invention was made with government support under grant no. HR0011-16-2-0029 awarded by The Department of Defense. The government has certain rights in the invention.

### FIELD OF THE INVENTION

The present disclosure provides systems and methods for the on-demand synthesis, separation, purification and formulation of chemicals, and particularly for the on-demand production of pharmaceutical products.

### BACKGROUND OF THE INVENTION

Most active pharmaceutical ingredients are prepared in large-scale discrete batch or semi-batch processes. The multi-step chemical synthesis, purification, formulation, and final packaging typically require large-scale facilities and expensive operations. The manufacturing typically uses batch processing at multiple locations. This approach generally requires long timescales to proceed from synthesizing of intermediates and chemical products and ingredients to the release of a finished pharmaceutical product. As a result, production of a finished chemical, product, or dosage form can require up to a total of 12 months, with large inventories of intermediates at several stages. Additionally, the facilities used to manufacture chemical products are typically designed for the manufacturing of a particular chemical or product and require extensive disassembly, cleaning, and reassembly in order to manufacture alternative chemical products.

Accordingly, there is a need for systems, kits, and methods capable of small molecules, fine chemicals, intermediates, as well as APIs and finished drug products in a single location in a continuous manner that can allow for a significant reduction in footprints of required facilities. In addition, the use of continuous-flow synthesis in a compact, reconfigurable manufacturing system can allow for high-throughput, on-demand production of chemical products including API and intermediates at a greatly reduced cost.

### SUMMARY OF THE INVENTION

One aspect of the instant disclosure encompasses a unit operation module for use in a modular kit system for manufacturing a chemical composition. The unit operation module comprises a chassis; a unit operation module controller affixed in the chassis, wherein the unit operation module controller is operable to control a unit operation performed by the unit operation module in a process of manufacturing a chemical composition and wherein the unit operation controller is operable to receive sensor data and communicate with one or more controllers; a unit operation component affixed in the chassis, wherein the unit operation component is selected from the group consisting of reactors, separators, filter washer dryers, crystallizers, sterilizers, formulators, evaporators, and any combination thereof; one or more fluidic connections operable to fluidically connect two or more unit operation modules; and one or more ancillary component selected from vessels, temperature control devices, mixers, valves, sensors, pumps, power supplies, and any combination thereof. The unit operation module is operable to be configured to perform the unit operation in the process of manufacturing the chemical composition.

In some aspects, the unit operation component is a reactor. The reactor can be a plug flow reactor (PFR), a stirred tank reactor (STR), or a continuously stirred tank reactor (CSTR). In some aspects, the plug flow reactor module comprises a PFR and further comprises a power supply, a temperature control device, one or more diverter valves fluidically connected to the one or more fluidic connections, one or more pumps, a backpressure regulator, two or more vessels, and one or more mixers.

In some aspects, the unit operation module is a stirred tank reactor module and the stirred tank reactor module comprises a STR and/or a CSTR and further comprises a power supply, a temperature control device, one or more diverter valves fluidically connected to the one or more fluidic connections, one or more pumps, a backpressure regulator, two or more vessels, and one or more mixers. In other aspects, the unit operation module is a separator module and the separator module comprises a gravity separator, a filter washer dryer (FWD), a column, or any combination thereof and further comprises a power supply, one or more diverter valves fluidically connected to the one or more fluidic connections, one or more pumps, a separator, two or more vessels, and one or more mixers.

In some aspects, the unit operation module comprises a membrane separator and further comprises a power supply, one or more diverter valves fluidically connected to the one or more fluidic connections, one or more pumps, a membrane separator, two or more vessels, and one or more mixers. In other aspects, the unit operation module is a separator module and the separator module comprises a filter washer dryer (FWD) and further comprises a power supply, one or more diverter valves fluidically connected to the one or more fluidic connections, one or more pumps, two or more vessels, and one or more mixers. In yet other aspects, the unit operation module comprises an evaporator and further comprises a power supply, at least one gas inlet and outlet, a heating element, a thermocouple, one or more diverter valves fluidically connected to the one or more fluidic connections, one or more pumps, a pressure regulator, an evaporation unit, and two or more vessels.

In some aspects, the unit operation module controller acts as input/output boards relaying instructions out to the unit operation component and ancillary components and receiving information from the unit operation component and ancillary components.

Another aspect of the instant disclosure encompasses a modular kit system for use in manufacturing chemical compositions. The modular kit system comprises two or more fluidically connected unit operation modules each configured to perform a unit operation in chemical synthesis processes. Each unit operation module comprises: a chassis; a unit operation module controller affixed in the chassis, wherein the unit operation module controller is operable to control a unit operation performed by the unit operation module in a process of manufacturing a chemical composition and wherein the unit operation controller is operable to receive sensor data and communicate with one or more controllers; a unit operation component affixed in the chassis, wherein the unit operation component is selected from the group consisting of reactors, separators, filter washer dryers, crystallizers, formulators, evaporators, and any combination thereof; one or more fluidic connections operable to fluidically connect two or more unit operation modules; and one or more ancillary components selected from vessels, temperature control devices, mixers, valves, sensors, pumps, power supplies, and any combination thereof; and a kit system master controller in electronic communication with each unit operation module controller, wherein the master system controller is operable to be programmed to execute a chemical synthesis process for manufacturing a chemical composition of interest. Providing the modular kit system with precursors and reagents and activation of the modular kit system synthesizes the chemical composition of interest.

In some aspects, the modular kit system comprises a reactor module, a separator module, a crystallizer module, and a filter washer dryer module. The reactor module can comprise a reactor selected from the group consisting of a plug flow reactor (PFR), a stirred tank reactor (STR), and a continuously stirred tank reactor (CSTR).

In some aspects, the reactor module comprises a PFR and the reactor module further comprises a power supply, a temperature controller, one or more diverter valves fluidically connected to the one or more fluidic connections, a heating element, one or more pumps, a backpressure regulator, two or more vessels, and one or more mixers. In other aspects, the reactor module comprises a STR or a CSTR and the reactor module further comprises a power supply, a temperature controller, one or more diverter valves fluidically connected to the one or more fluidic connections, a heating element, one or more pumps, a backpressure regulator, two or more vessels, and one or more mixers. In yet other aspects, the separator module comprises a membrane separator and further comprises a power supply, one or more diverter valves fluidically connected to the one or more fluidic connections, one or more pumps, a membrane separator, two or more vessels, and one or more mixers.

An additional aspect of the instant disclosure encompasses a programmed kit system (pharmacy on demand; “PoD”) unit to produce and provide pharmaceutical precursor molecules, and/or active pharmaceutical ingredients (API) and/or finished pharmaceuticals directly to one or more subjects in need thereof, within minutes to weeks of manufacturing. The PoD unit comprises two or more fluidically connected unit operation modules each configured to perform a unit operation in chemical synthesis processes of the PoD, wherein each unit operation module comprises: a chassis; a unit operation module controller affixed in the chassis, wherein the unit operation module controller is operable to control a unit operation performed by the unit operation module in a process of manufacturing a chemical composition and wherein the unit operation controller is operable to receive sensor data and communicate with one or more controllers; a unit operation component affixed in the chassis, wherein the unit operation component is selected from the group consisting of reactors, separators, filter washer dryers, crystallizers, formulators, evaporators, and any combination thereof; one or more fluidic connections operable to fluidically connect two or more unit operation modules; and one or more ancillary components selected from vessels, temperature control devices, mixers, valves, sensors, pumps, power supplies, and any combination thereof. The PoD further comprises a kit system master controller in electronic communication with each unit operation module controller, wherein the master system controller is programmed to execute a chemical synthesis process for manufacturing a chemical composition of interest. wherein providing the PoD with precursors and reagents and activation of the modular kit system synthesizes the chemical composition of interest.

One aspect of the instant disclosure encompasses a method for making a chemical composition using the system of any one of the preceding claims. The method comprises determining the number and type of unit operation modules necessary to synthesize a chemical composition of interest; fluidically and electronically connecting the unit operation modules to each other in a predetermined sequence; programming the kit system master controller to execute the chemical synthesis process of the chemical composition of interest using the one or more of the unit operation module kits; adding all of the reagents and precursors to the vessels of the unit operation module kit as determined in the first step; and activating the system to prepare the chemical composition of interest.

Another aspect of the instant disclosure encompasses systems and methods for the touchless detection, quantification, monitoring and/or analysis of a fluid sample in a container, comprising (i) a container comprised of one or more translucent or transparent materials and comprising an internal volume suitable for receiving, retaining and/or transferring the fluid sample, and (ii) one or more touchless measurement apparatuses adapted to measure one or more of volume, weight, analyte identity and/or concentration, flow rate, temperature, pressure, turbidity, color, reagent use, reagent verification, and product verification.

In some aspects, the system for touchless detection is part of an on-demand continuous-flow apparatus for the production of chemicals. In some aspects, the system for touchless detection is part of an on-demand batch type formulation of chemicals.

In some aspects, the system for touchless detection is a touchless detection unit operation module that can be used in a kit system. In some aspects, the instant disclosure comprises kit systems and methods for the on-demand synthesis of chemical compounds, comprising one or more of: (i) one or more reagent holding/dispensing containers, (ii) one or more continuous-flow chemical synthesis modules, (iii) one or more of filtration, wash, crystallization, and/or separation modules; (iv) a touchless measurement system for the quantification, monitoring and/or analysis of a fluid sample in a container, comprising one or more containers comprised of: one or more translucent or transparent materials and comprising an internal volume suitable for receiving, retaining and/or transferring the fluid sample; one or more touchless measurement apparatus adapted to measure one or more of volume, weight, solute concentration, flow rate, temperature, turbidity, color, reagent verification, and product verification of the fluid sample in the container; and (iv) one or more processors and/or controller units in communication with one or more of the touchless measurement apparatus, and to one or more reagent holding/dispensing modules, one or more continuous-flow chemical synthesis modules, and one or more of formulation, filtration, wash, crystallization, and separation modules.

In some aspects, the fluid sample comprises one or more analyte. The analyte may be a small molecule, pharmaceutical precursor, a crude active pharmaceutical ingredient (API), a purified API, a finished API formulation, an impurity, a small molecule, an amino acid, a peptide, a protein, a glycoprotein, and a biologic. In some aspects, the touchless measurement apparatus is adapted for spectroscopic analysis, ultrasonic detection and/or optical detection. The spectroscopic analysis can be one or more of UV/Vis spectroscopy, NIRF spectroscopy, Fourier-transform infrared spectroscopy (FTIR) spectroscopy and Raman spectroscopy.

### BRIEF DESCRIPTION OF THE FIGURES

The following drawings form part of the present specification and are included to further demonstrate certain aspects of the present disclosure. Certain aspects can be better understood by reference to one or more of these drawings in combination with the detailed description of specific aspects presented herein.

FIG. 1A shows a schematic representation of the general concept of the present invention, in which a library of unprogrammed unit operation modules can be programmed to perform a specific unit operation step in a multistep process for manufacturing chemical and biological compounds. The programmed unit operation modules are assembled into one or more programmed modular kits to produce a chemical of interest, for example, an API or finished drug product.

FIG. 1B shows a schematic representation of three aspects of modular kit systems assembled and programmed to manufacture three different APIs—benzyl fentanyl, midazolam, and cisatracurium besylate. For each column, each unit operation module that assembled into the kits is programmed differently depending on the precursor/API being made.

FIG. 2 shows a representative Piping and Instrumentation Diagram (PID) for an example set of unit operations comprised of the defined synthetic and purification step sequences. The PID describes the equipment for use in kits and defines the kit number and type.

FIG. 3A shows schematic representations of a fixed chassis kit system. In this aspect, a programmed module kit for making a midazolam precursor having a fixed chassis design that incorporates feedstocks is shown.

FIG. 3B shows schematic representations of a flexible chassis/modular kit system. In this aspect, a flexible module kit chassis design where multiple modules programmed for different chemicals of interest can be housed together is shown.

FIG. 4 shows the unit operation modules in a formulator module kit, and particularly for IV medicine production.

FIG. 5 shows an aspect of a flow diagram for an aspect of a formulator module or programmed formulator kit to create IV medicines from API input.

FIG. 6 shows an aspect of a Plug Flow Reactor (PFR) unit operation module.

FIG. 7 shows an aspect of a Continuous Stirred Tank Reactor (CSTR) unit operation module.

FIG. 8 shows an annotated picture of a Gravity Separator unit operation module.

FIG. 9 shows an embodiment of a Filter Washer Dryer unit operation module.

FIG. 10 shows an embodiment of an Evaporator unit operation module.

FIG. 11A shows the schematic of unit operation modules programmed to be the kit system for producing the diisopropylhydroxybenzoic acid (DIHA) precursor for propofol.

FIG. 11B shows the unit operation modules programmed to be the kit system for producing the diisopropylhydroxybenzoic acid (DIHA) precursor for propofol.

FIG. 12A shows the schematic of unit operation modules programmed to be the kit system for producing ciprofloxacin precursor, 2,4,5-trifluorobenzoyl chloride (TBC). The figure also shows the chemical synthesis route.

FIG. 12B shows the unit operation modules programmed to be the kit system for producing the TBC precursor for ciprofloxacin.

FIG. 13 shows the NMR data used to verify production of the TBC product.

FIG. 14A shows the schematic of unit operation modules programmed to be the kit system for producing the cisatracurium precursor amide. The figure also shows the chemical synthesis route.

FIG. 14B shows the unit operation modules programmed to be the kit system for producing the precursor amide for cisatracurium.

FIG. 15 shows NMR data for the cisatracurium precursor amide production.

FIG. 16A shows the schematic of unit operation modules programmed to be the kit system for producing the midazolam amide precursor. The figure also shows the chemical synthesis route.

FIG. 16B shows an aspect of unit operation modules programmed to be a kit system for producing the precursor midazolam amide.

FIG. 17 shows the NMR data for the acid chloride step for the production of midazolam amide precursor.

FIG. 18 shows a computer system in the form of a computer 210 for monitoring, automation and control of the systems for the production of a chemical product.

FIG. 19 shows one aspect of the system of the present invention comprising a transmissive flexible container, in this example, an IV bag holder used in the spectroscopic analysis of IV bag samples having light transmissive contents.

FIG. 20 shows the reflective interrogation of the inventive system, wherein the system comprises a container, in this example, an IV bag having contents that are opaque to light transmission.

FIG. 21A shows the results of an aspect of the system using a wide gap such that the exemplary IV bag freely floats within the space (3 cm

FIG. 21B shows the results of an aspect when the system comprises a tight gap, which firmly clasped each side of the bag (1 cm), was used in the transmissive measurement.

FIG. 22 shows a plot from an aspect of the system comprising HDX-XR and FlameNIR spectrometers to show the total fluid activities from 200 nm to 1600 nm for the exemplary IV bag containers containing cisatracurium (Cis) and cis-placebo. The inset plot of the UV region highlights the unique activity of Cis-placebo versus water and Cis-drug versus placebo showing the 270-300 nm band which is unique to Cis drug product in an aspect of this system and shows how it is used to perform concentration analysis.

FIG. 23A summarizes the results of an aspect of the system comprising a UV-Vis spectrometer where the UV-Vis scans with the 90° trends.

FIG. 23B summarizes the results of an aspect of the system comprising a UV-Vis spectrometer where the UV-Vis scans with the 45° trends.

FIG. 24A shows the results of an aspect of the system comprising a Raman spectrometer, wherein the 785 nm Raman scan through the walls of the containers. The inset plot shows results for the dark condition, sample holder, and empty IV bag container to show those activities versus the more primary analytes, such as, for example, propofol, lecithin, soybean oil, and benzyl alcohol.

FIG. 24B shows the results of an aspect of the system comprising a Raman spectrometer, wherein the 785 nm Raman scan through the walls of the containers.

FIG. 25A shows an aspect of the system comprising volume detection and monitoring using a rigid container (Nalgene bottle). The figure shows the original frame of the bottle.

FIG. 25B shows an aspect of the system comprising volume detection and monitoring using a rigid container (Nalgene bottle). The figure shows the system of the present disclosure is using the region of interest from open-source software, Open-Source Computer Vision Library (OpenCV), after applying a Canny edge detection module.

FIG. 25C shows an aspect of the system comprising volume detection and monitoring using a rigid container (Nalgene bottle). The figure shows the application of a Probabilistic Hough Transform in the system of the present invention to obtain vertical and horizontal lines. A filter is applied to only keep the liquid-level line.

FIG. 25D shows an aspect of the system comprising volume detection and monitoring using a rigid container (Nalgene bottle). The figure shows the system where the image is overlaying the cropped region of interest frame.

FIG. 26 shows an aspect of the system for detection and monitoring of the liquid level in a rigid container using a QR-code obstructing the cropped image view.

### DETAILED DESCRIPTION

The devices, systems, kits, modules, methods, and computer program products for manufacturing chemical compositions will be understood from the accompanying drawings, taken in conjunction with the accompanying description. It is noted that, for purposes of illustrative clarity, certain elements in various drawings can not be drawn to scale. Several variations of the system are presented herein. It should be understood that various components, parts, and features of the different variations can be combined together and/or interchanged with one another, all of which are within the scope of the present application, even though not all variations and particular variations are shown in the drawings. It should also be understood that the mixing and matching of features, elements, and/or functions between various variations is expressly contemplated herein so that one of ordinary skill in the art would appreciate from this disclosure that the features, elements, and/or functions of one variation can be incorporated into another variation as appropriate, unless described otherwise.

The present disclosure provides modules, kits, systems, and methods for the on-demand synthesis, separation, purification, and formulation of chemical products, and can be in connection with on-demand continuous-flow chemical production. More specifically, the present disclosure provides unit operation modules and modular kit systems assembled using the unit operation modules. The modular kit systems can be assembled and programmed into programmed kit systems for use in manufacturing chemical compounds.

The ability to manufacture many different types of chemical products (e.g., small molecules, pharmaceutical precursors, crude active pharmaceutical ingredients (API), purified API, finished API formulations, impurities, amino acids, peptides, proteins, glycoproteins and/or biologics) on demand, in a self-contained, and/or readily reconfigurable continuous-flow chemical process provided by systems, kits, modules and methods of the instant disclosure offer significant advantages over large-scale batch processing.

### I. Modular Kit System

One aspect of the instant disclosure encompasses a kit system for use in manufacturing desired chemical or biological compositions (e.g., small molecules, pharmaceutical precursors, crude active pharmaceutical ingredients (API), purified API, finished API formulations, impurities, amino acids, peptides, proteins, glycoproteins and/or biologics). The kit system of the instant disclosure can be assembled from unit operation modules and can be programmed into programmed kit systems to perform the on-demand synthesis, separation, purification, and formulation of chemical products.

The kit system of the instant disclosure comprises two or more fluidically connected unit operation modules each configured to perform a unit operation (e.g., reactor, separator, crystallizer, filter, formulator, etc.) in chemical synthesis and formulation processes. The unit operation modules can be as described in Section II herein below.

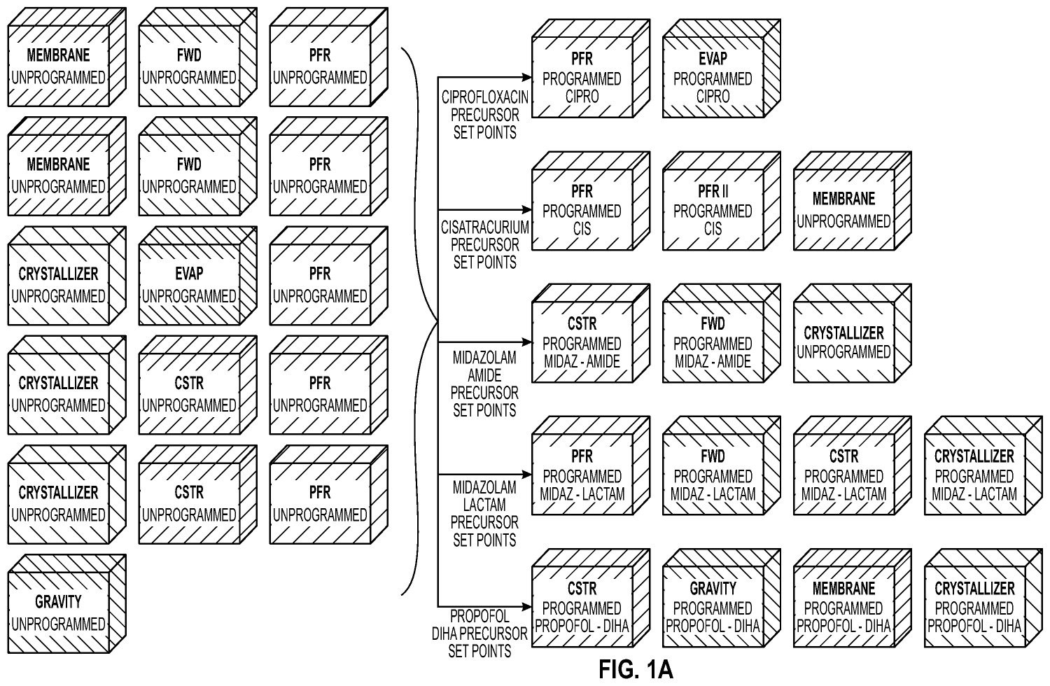

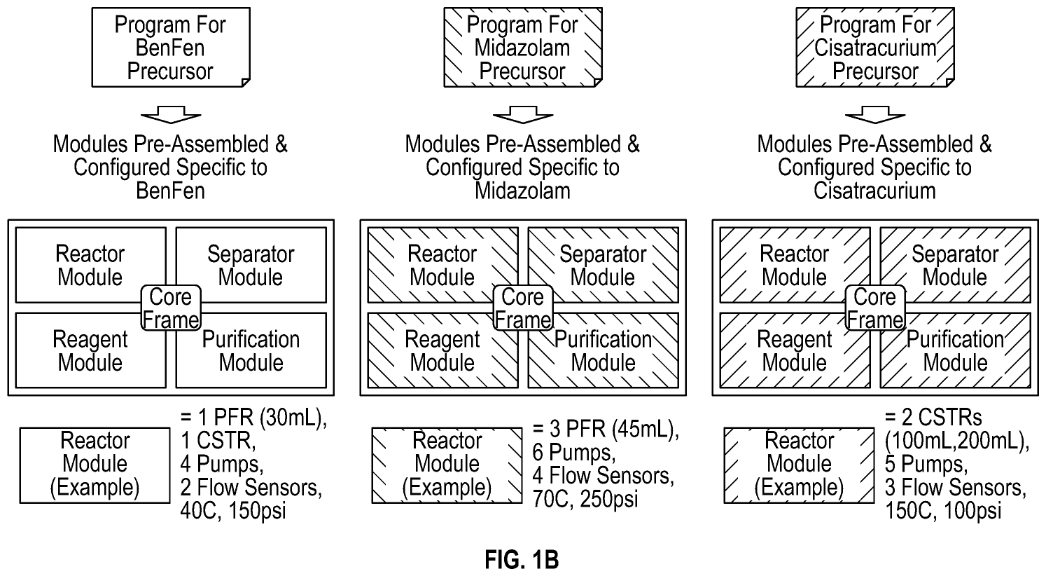

The kit system of the instant disclosure can be a modular kit system. FIGS. 1A and 1B illustrate the modular kit approach that is enabled by a kit system of the instant disclosure comprising unit operation modules configured for performing one or more unit operations in multistep processes for manufacturing chemical or biological compounds of interest. FIG. 1A shows a schematic representation of the general concept of the present invention, in which a library of unit operation modules can be configured to perform a specific unit operation step in a multistep process for manufacturing chemical and biological compounds. The configured unit operation modules are assembled into one or more kit systems that can be programmed to produce a chemical composition of interest, for example, an API or finished drug product. FIG. 1B shows a schematic representation of three aspects of programmed kit systems assembled and programmed to manufacture three different APIs—benzyl fentanyl, midazolam, and cisatracurium besylate. For each column, each unit operation module assembled into the kit system is programmed differently depending on the precursor/API being made.

The modular approach to the modular kit systems of the instant disclosure provides a range of benefits and is a fundamental shift in chemical, precursor, API, and formulated API production. The modular approach enables a single kit design to be reused as a part of producing a range of desired products. The kit system approach simplifies the logistics and maintenance of the systems by users via a “remove and replace” sustainment approach. The kit system approach is fundamentally portable, meaning that material handling equipment based on kit system weight can be adjusted accordingly. In some aspects, an open architecture frame of the kit systems enables quick cleaning and sustainment, allows for simplified routing of interconnections between assembled kits, and supports the extraction of waste gases generated during precursor production operations.

The kit system of the instant disclosure can be assembled from unit operation modules and can be programmed into programmed kit systems to perform the on-demand synthesis, separation, purification, and formulation of chemical products, in an on-demand continuous-flow chemical composition production process. As used herein, the term “continuous-flow” when used in the context of chemical production using kits and kit systems of the instant disclosure refers to chemical production wherein the products of each module can be substantially continuously transported from one module to the other until a target chemical product of the kit is produced. This is in contrast to the batch processing methods currently used in chemical synthesis, purification, formulation, and final packaging of chemical compositions at multiple locations that typically require large-scale facilities and expensive operations. “On-demand” manufacturing allows a product to be prepared as needed, in volumes that match the demand, and at a location proximate to its site of use, in contrast to the traditional warehousing and distribution schemes.

Using the kit systems of the instant disclosure, each functioning unit operation module (e.g., reactor, separator, crystallizer, filter, formulator, etc.) within the process defined in the kit, can be operated in a continuous and/or semi-continuous manner, such that the products of each module can be substantially continuously transported from one module to the other until a target chemical product of the kit is produced. In some aspects, the chemical product is an API intermediate, an API, or a formulated finished drug product.

The kit system also comprises a kit system master controller. The system master controller is capable of being in electronic communication with, and control of one or more unit operation module controllers. The master system controller is operable to be programmed to execute a chemical synthesis and/or formulation process for manufacturing a chemical composition of interest at programmed reaction conditions. The kit system master controller can comprise one or more of a CPU, a memory unit, a human machine interface (HMI), multiple i/o system control software.

The modular kit system can be assembled into a programmed kit system by fluidically connecting the two or more unit operation modules in combination, placing unit operation modules in electronic communication with the kit system master controller, and programming the system master controller to perform the synthesis of the chemical composition of interest using the one or more unit operation modules. When provided with precursors and reagents, a programmed kit system can be activated to synthesize the chemical composition of interest.

A kit system of the instant disclosure can also comprise basic infrastructure, including, but not limited to one or more of the following: a venting and waste management capability, a source of local utility such as, for example, deionized water, and N₂, and an electronic control architecture between the various unit operation modules of an assembled system, which runs the overall program. In some aspects, this electronic control can be performed using a computer and an embedded user interface. The modular kit system can further comprise vessels comprising chemical precursors, reagents, and/or solvents necessary for the synthesis of the chemical composition of interest and can further comprise vessels for the collection of reaction products and waste streams and the chemical composition of interest. The vessels can be ancillary components of the one or more unit operation modules of the kit system.

Kit systems can exist inside, inserted into, or attached to a modular, stackable, reconfigurable rigid metal or polymer frame, scaffold, or enclosure. Unit operation modules can be affixed in the frame, scaffold, or enclosure. Alternatively, when the unit operation modules used for assembling the kit system comprise a chassis, the chassis of the unit operation modules can be used to assemble the frame, scaffold, or enclosure of the kit system.

Kit systems can be assembled in different configurations based on the sequence to produce the target chemical or composition and other design or production factors. Kit systems, prior to programming, can include universal modules to enable re-use across a range of target product production sequences. Automation can occur within the subsystems and between subsystems to create the desired product.

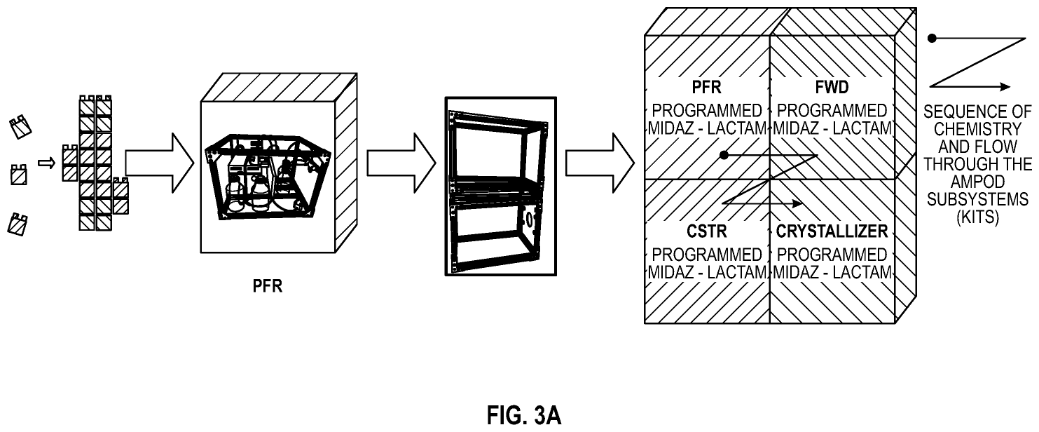

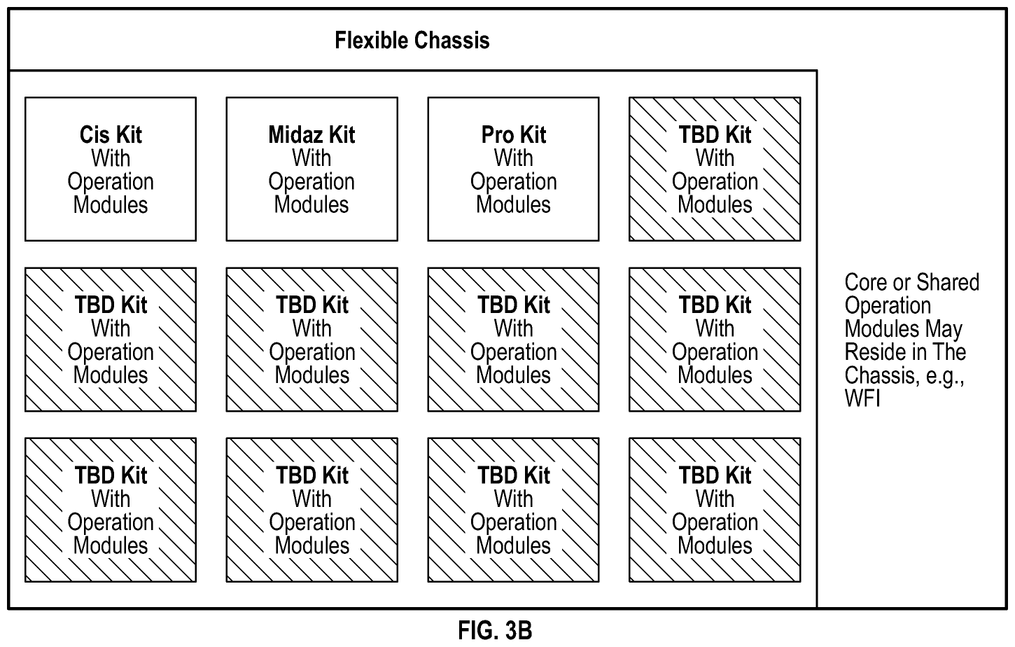

In some aspects, a kit system can be assembled into a programmed kit system that yields an intermediate necessary for drug product production (e.g., the cipro SYU module produces crude Cipro API). In one aspect, depicted in FIG. 3A, different modules are configured, programmed, and assembled into a kit for producing a particular chemical product (such as, for example, a midazolam precursor). In some aspects, a system is a combined/linked set of kits or subsystems that yields a desired product output (e.g., purified API, API tablets, etc.). In some aspects, an array of one or more kits can be plugged into a single chassis (FIG. 3B) or a plurality or chassis.

In some aspects, each chemical, API precursor, API and/or formulated API is produced by at least one programmed kit system needed to make that particular chemical or API precursor, API and/or formulated API, and each programmed kit system requires only minimal support (i.e., power, etc.).

Each kit system can also be a master kit system comprising an integrated set of programmed kit systems, wherein one kit system is programmed to manufacture a particular chemical composition that can serve as a precursor in a chemical synthesis process by another kit system of the master kit system. In some aspects, the master kit system comprises kit systems programmed to manufacture a chemical composition and one or all precursors that can be used to manufacture the chemical composition. In some aspects, the master kit system comprises kit systems programmed to manufacture an API and/or formulated API and precursors of the API that can be used to manufacture the API and/or formulated API. The master kit system can be assembled into a single chassis. An important attribute of the systems is that each chemical, precursor, or API can be in a dedicated kit or system to eliminate the risk of cross-contamination.

This system can use an input of power, pre-packed containers (i.e., cartridges, bags) of starting materials, solvents and excipients that give an output of a chemical, API precursor, API or formulated API ready for further processing through a fill finish unit. The pre-packed containers can be restocked as required akin to a vending machine or printer. The set of chemicals, API precursors, or APIs can use common equipment, which can use clean-in place protocols or disposable wetted parts to reduce or eliminate cross-contamination.

In some aspects, the kit systems of the instant disclosure are sufficiently small such that they are suitable for manufacturing pharmaceuticals or finished drug products which are to be directly distributed and/or deployed to pharmacies, hospitals and eventually to consumer residences rather than depend on pharmaceuticals from a large manufacturing plant. For example, the kit systems of the instant disclosure can be of a size to fit within a room of a building, or ship or plane, to something that would fit on a tabletop or in a van or truck.

The unit operations modules for taking starting materials through chemical processing, purification and formulation to produce the formulated drug product are coincident regardless of the fixed vs. flexible chassis design for the system. In some aspects, a system can comprise a series of modules in fluid and electrical connection to each one and each other including, but not limited to, one or more of: reactors, separators, filters, filter/washer/dryers, crystallizers; crystallizer/filter/washer/dryers; heaters, coolers, vents, formulators, and tableters.

The present disclosure provides automated chemistry platforms based on one or more modular kits, where modules can comprise control systems, and one or more of the following, including for example, pumps, valves, reagents, reactors, holding tanks, filters, driers, formulators are automated at the and then the kits are assembled into systems of kits. Each kit can be programmed, where the program comprises a combination of the following three elements: raw material inputs; chemical processes; and hardware & software configurations.

In some aspects of the invention, the systems for the production of a chemical product, API and/or formulated drug product are compact. The systems can be scalable and reconfigurable to make gram quantities up to hundreds of kilograms of product. The systems can be sized to fit on a tabletop or benchtop. Such systems can have dimensions, for example from about 4 to about 7 feet in length, about 2 to about 5 feet in width, and about 3 to about 6 feet tall. In these aspect, each module in the system can be approximately 1 to 2 feet on a side. Alternatively, the system can be somewhat larger and suitable for use in a truck bed or trailer. For instance, such systems can have dimensions ranging from about 8 to about 15 feet in length, about 6 to about 10 feet in width, and about 5 to about 10 feet tall. In these aspects, each module in the system can be approximately 2 to 5 feet on a side. In alternate aspects, the systems can be scaled even larger and have much larger dimensions, such as would fit within a cargo container or series of containers. The approach and systems provided herein are appropriate for systems having smaller dimensions and using smaller modules, as well as for systems having larger dimensions and having larger modules.

In some aspects, the modular kit system comprises a reactor module, a separator module, a crystallizer module, and a filter washer dryer module. In some aspects, the reactor module comprises a reactor selected from the group consisting of a plug flow reactor (PFR), a stirred tank reactor (STR), and a continuously stirred tank reactor (CSTR). In some aspects, the reactor module comprises a PFR and the reactor module further comprises a power supply, a temperature controller, one or more diverter valves fluidically connected to the one or more fluidic connections, a heating element, one or more pumps, a backpressure regulator, two or more vessels, and one or more mixers. In some aspects, the separator module comprises a membrane separator and further comprises a power supply, one or more diverter valves fluidically connected to the one or more fluidic connections, one or more pumps, a membrane separator, two or more vessels, and one or more mixers.

In some aspects, the modular kit system comprises a STR or a CSTR reactor module, a separator module, a crystallizer module, and a filter washer dryer module. The reactor module can further comprise a power supply, a temperature controller, one or more diverter valves fluidically connected to the one or more fluidic connections, a heating element, one or more pumps, a backpressure regulator, two or more vessels, and one or more mixers. In some aspects, the separator module comprises a membrane separator and further comprises a power supply, one or more diverter valves fluidically connected to the one or more fluidic connections, one or more pumps, a membrane separator, two or more vessels, and one or more mixers

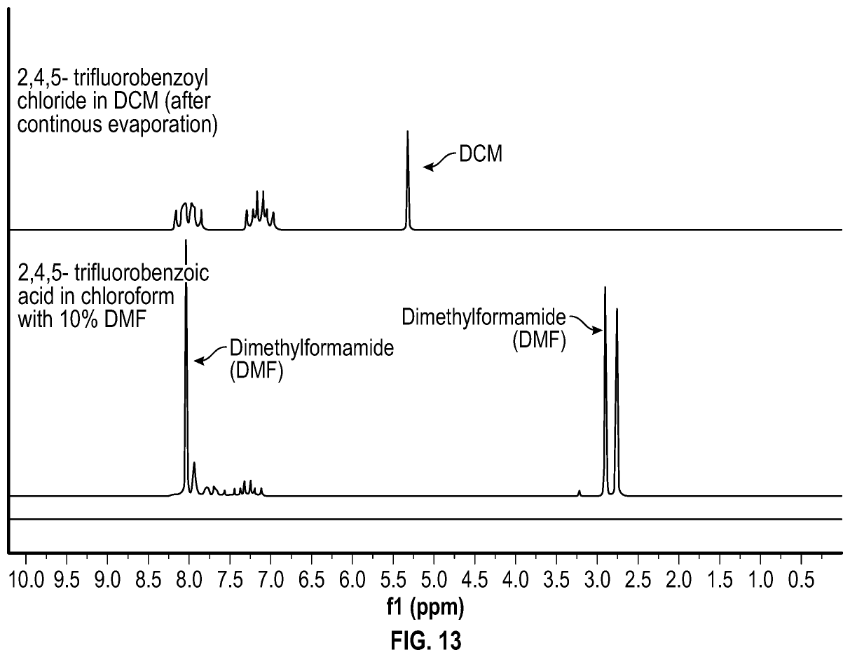

In some aspects, a modular kit system of the instant disclosure is a modular kit system for producing diisopropylhydroxybenzoic acid (DIHA), a precursor for the API propofol. In some aspects, the kit system for producing DIHA comprises a CSTR reactor module, two gravity separator modules, and a filter washer dryer module. In some aspects, the kit system for producing DIHA is assembled and programmed as shown in FIG. 13A and FIG. 13B.

In some aspects, a modular kit system of the instant disclosure is a modular kit system for producing 2,4,5-trifluorobenzoyl chloride (TBC), a precursor for the API ciprofloxacin. In some aspects, the kit system for producing TBC comprises a PFR reactor module and an evaporator module. In some aspects, the kit system for producing DIHA is assembled and programmed as shown in FIG. 14A and FIG. 14B.

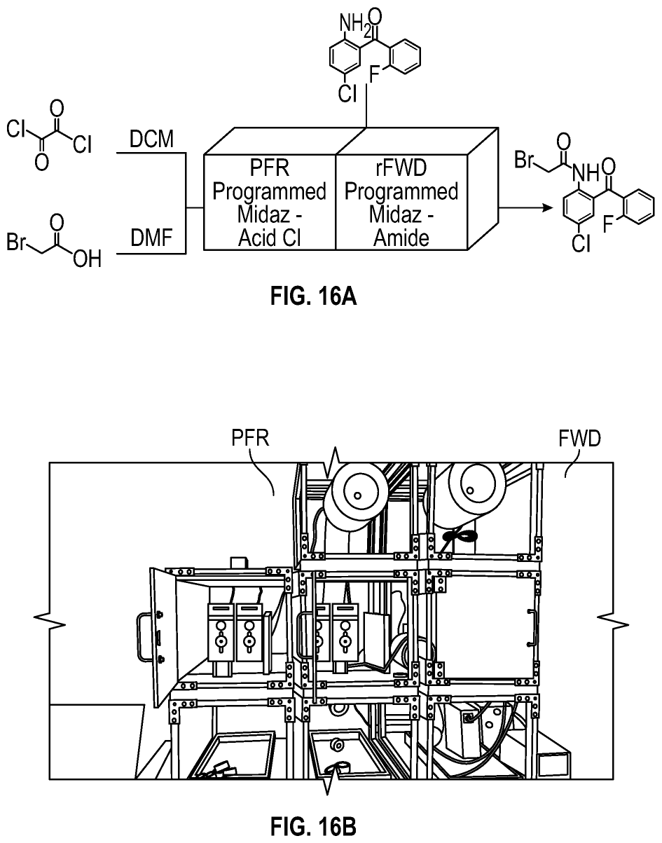

In some aspects, a modular kit system of the instant disclosure is a modular kit system for producing the amide intermediate to cisatracurium. In some aspects, the kit system for producing the amide intermediate comprises two PFR reactor modules. In some aspects, the kit system for producing the amide intermediate is assembled and programmed as shown in FIG. 16A and FIG. 16B.

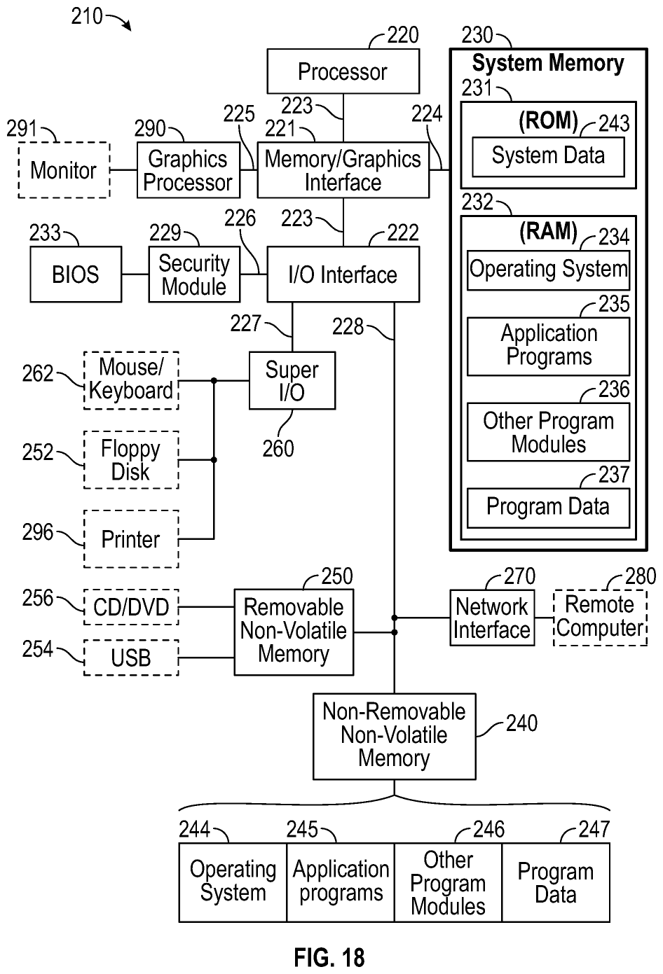

In some aspects, a modular kit system of the instant disclosure is a modular kit system for producing midazolam (Midaz) lactam precursor. In some aspects, the kit system for producing the Midaz lactam precursor comprises a PFR reactor module and a reactive filter washer dryer (rFWD). In some aspects, the kit system for producing the Midaz lactam precursor is assembled and programmed as shown in FIG. 18A and FIG. 18B.

### II. Unit Operation Modules

Another aspect of the present disclosure encompasses a unit operation module for performing one or more unit operations in processes for manufacturing chemical or biological compositions. A unit operation module of the instant disclosure comprises a chassis; a unit operation module controller affixed in the chassis; a unit operation component affixed in the chassis; one or more fluidic connections operable to fluidically connect two or more unit operation modules; and one or more ancillary component affixed in the chassis to enable the functioning of the unit operation component and connection with other unit operation modules. In some aspects, two or more of the unit operation modules can be assembled into a modular kit system for manufacturing a chemical composition. The modular kit system can be as described in Section I herein above.

A unit operation module controller of the unit operation module can be operable to control a unit operation performed by the unit operation module in a process of manufacturing a chemical composition. The unit operation controller can also be operable to receive sensor data and communicate with one or more controllers such as a master controller or a controller of another unit operation module. The controller can have a CPU, memory, and i/o function, which can communicate with one or more other controller systems.

The unit operation modules of the instant disclosure also comprises a unit operation component affixed in the chassis. The unit operation component is operable to perform a unit operation of a chemical manufacturing process. Unit operations in chemical manufacturing processes and include, filtering, washing, drying, crystallization, separating, formulating, evaporating, etc. Non-limiting examples of unit operation components that can perform these functions can include reactors, separators, filters, washers, dryers, crystallizers, formulators, evaporators, and any combination thereof. In some aspects, the unit operation component is selected from the group consisting of reactors, separators, filter washer dryers, crystallizers, formulators, evaporators, and any combination thereof.

Ancillary components of the instant disclosure are operably connected to the unit operation component, the chassis or the fluidic connections of the module and enable the functioning of the unit operation component and connection with other unit operation modules. Non-limiting examples of ancillary components include vessels, temperature control devices, mixers, valves, sensors, pumps, power supplies, and any combination thereof. Ancillary components can be as described in Section II(h) herein below. One or more fluidic connections are operable to fluidically connect two or more unit operation modules. The unit operation module is operable to be configured to perform the unit operation in the process of manufacturing the chemical composition.

As used herein, a unit operation module refers to an unprogrammed unit operation or combination of unit operations (e.g., for example, PFRs, CSTRs, FWDs, homogenizers, UV detectors, solvents, or reagent supplies). Unit operation modules can then be programmed and adjusted during process development to establish parameters and realize a robust and reproducible process. Once a specific unit operation module is assembled for a unit operation, the operation of the module can be refined to a particular intermediate/product to determine its parameters in the refined unit operation for operation within a programmed kit system. Accordingly, in some aspects, unprogrammed unit operation modules (program-capable subsystems) are programmed based on experimentally defined parameters and one or more modules are combined to produce target chemical products (precursors, API, formulated API, etc.) as a kit system. The programmable modules provide a large pool of unit operation capabilities that contain a broader range of operating parameters (e.g., temperature, pressure, flow rate) and form factors (e.g., size/volume, material composition) that provide the tools and flexibility to design chemical processes (synthesis, purification, and formulation) for one or more kits. Once a unit operation is defined, a given module can be repurposed to implement similar unit operation sequences to produce a range of precursors/products by simply changing the parameters and sequential configuration of the kits.

As used herein, a configured unit operation module (subsystem) refers to a unit operation module that has been configured (programmed) to do a singular, targeted job such as a PFR module programmed specifically to run a specific chemical reaction for a chemical synthesis process or an API synthesis process, a homogenizer unit operation module programmed to homogenize a drug (such as propofol) emulsion formulation, a reagent module programmed to deliver reagents to a cipro synthesis module or (SYU). Other aspects include, but are not limited to, an FWD module to purify crude chemicals through filtration, washing, drying, and a STR module to crystallize and purify crude chemicals.

The operations and components of the modules include, but are not limited to, dispensing of starting materials, reactors, separators/purification, crystallizers, filtration, dispensing of excipients, mixers, homogenizers, pumps, filters, fillers, sterilizers, and packagers. In some aspects, the sensor(s) of the detection system(s) can be electronically coupled to one or more processors and controller units as part of the continuous-flow synthesis apparatus, either as a stand-alone unit or part of a distributed network of apparatuses.

In some aspects, unit operation modules of the instant disclosure can be pre-assembled unit operation modules can be used in a programmatic approach with specific set points (e.g., temperature, pH, flow rates, and pressure) that are specifically configured to build a targeted kit system. In other aspects, unit operation modules of the instant disclosure can be assembled to perform a specific unit operation of a process and adjusting the set points (e.g., temperature, pH, flow rates, and pressure) as needed to specifically configure a targeted kit system.

### (a) Reactor Modules

One aspect of the instant disclosure encompasses a reactor module. A reactor module further comprises a reactor and ancillary components operably connected to the reactor, a chassis, or fluidic connections of the module, and enable the functioning of the reactor and connection with other unit operation modules. The reactor module can be configured to perform one or more chemical reactions. The reactor module can be configured to receive chemical reactant(s) and optionally solvent(s), for example from containers or reservoirs containing the chemical reactant(s) and solvents, to produce a product in the vessel, which can be an intermediate of the final chemical product, or to produce the final chemical product directly. During operation, the reactor module can be configured for the continuous introduction of one or more reactants and/or solvents and to continuously output a chemical product (e.g., a chemical product, an intermediate chemical product, or an API). Alternatively, the reactor module can be configured for semi-continuous production of an API or intermediate that can be transferred to a subsequent unit operation module for further processing. Any suitable type of reactor can be used. The one or more continuous reaction vessels can be, for example, a tube reactor, a PFR, a STR, or a CSTR.

Reactions take place in tubes or vessels in reactor modules that can require both heating and/or cooling of the fluid passing through. The tubes or vessels can be made of any chemically resistant material, such as certain polymers, metals (Hastelloy), glass, and ceramic, for example. The reactors can use different forms of heating and cooling including conductive, thermoelectric, resistive, impedance, and induction. It should be appreciated that other methods of heating and cooling known in the arts can also be used. For example, Heating/cooling can be either direct (technology applied directly to the vessel), or indirect (technology applied to a heat transfer medium [ex. fluid] that allows the technology to be remote to the vessel). In some aspects, the reactor modules known as SYUs can be constructed with in-line heat exchangers, however other exchangers, such as, but not limited to: tube-in-tube, plate heat exchangers, and/or fin and tube style exchangers. In these aspects, the plates are used both as a mechanical support capacity of the PFR tubing and as the heating and cooling. The plates and tubing allow for rapid heating and cooling of flowing reagents. In these aspects, the reagents do not come into contact with the plate.

The reactors in the modules can comprise tubing (including PFA tubing) with a conductive or resistive metal wrapped around the tube. Stainless steel can be wrapped around the tube, but it can be appreciated that any conductive metal or alloy can be used with similar conductive or resistive properties. The reactors can comprise a plastic coextruded or hybrid extruded with metal components having conductive elements. In some aspects, a thermo plastic is coextruded with a conductive wire. In some aspects, a plastic or silicone tube is coated with a metal or metal alloy in layers. These layers can be sprayed, glued, or affixed by other methods. Alternatively, the coextruded material can be created by starting with a base thermoplastic layer with granules fed into a hopper, then force die cast and cooled.

In some aspects, the reactors in the modules comprise mixing chambers that are machined from polytetrafluoroethylene and have a scalable capacity. The volume can range from 50 ml to 1 L to 2, 3, 4, 5 10, up to, and including 20 L or more. The mixing chambers can be made out of any polymeric and/or metals, metal alloys, e.g., PFA, Hastelloy™, stainless steel of various grades, etc. These mixing chambers can be jacketed or non-jacketed. Jackets can be machined out of a variety of materials, including, but not limited to, plastics, metals, ceramics, glass, or composite materials. In one aspect, the jacket material is solid nylon and has a liquid tight seal, such as an O-ring, that seals to the outer face of the mixing chamber when inserted into the jacket. The mixing chamber can be clamped into place with a metal ring that is screwed down to the jacket. The jacket can comprise quick disconnect lines (inlet and outlet) where coolant flows through the jackets to control the mixing chamber temperature. In aspects, the temperature can be over a range of 5-50° C., but it should be appreciated that various configurations can adjust this threshold above 50° C., and below 5° C. The non-jacketed vessels also have a ring to allow the lid to clamp to the mixing chamber. The lid seals to the mixing chamber with an O-ring. Other seal types can be used, including, for example, a sanitary seal.

Mixing in one or more of the reactors can be provided using an impeller attached to any rotary actuator, such as, for example, an electric motor, however, hydraulic or pneumatic options are also possible. In aspects, the pitched impeller is a PTFE coated pitched blade turbine, but other such impellers can be used such as hydrofoils, retreat curved or flat blade impellers. A set of baffles can be incorporated into the mixing chamber to improve mixing.

The reactor vessel of the reactor module can comprise one or more ports for solvent dispensing, motor connection, gas introduction, slurry transfers lines between vessels; a thermocouple for temperature monitoring; pH port, excess ports for manufacturing flexibility (ports can be sealed if not being used). The vessels use, but are not limited to, a compact motor which can be brushless, which is installed onto a metal motor mount. The motor is coupled to the stirrer that can reach up to 600 rpm. While not required, a custom enclosure can be made which protects the motor and circuit boards, controllers and wiring.

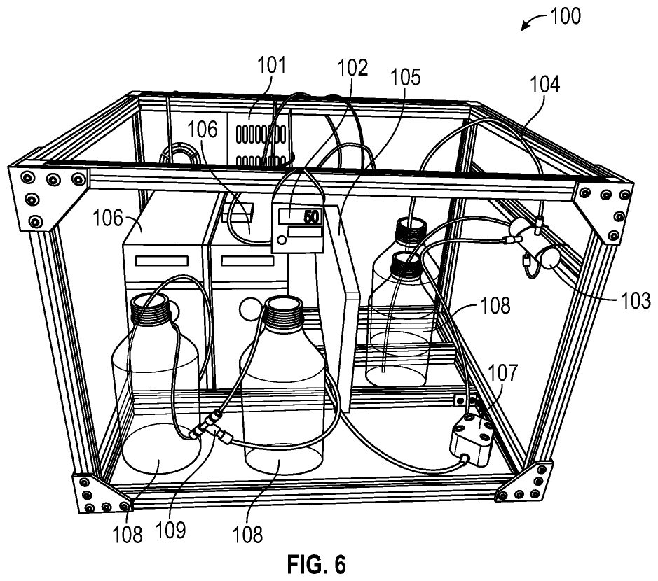

In one aspect, the reactor can be a PFR contained in a PFR unit operation module. The PFRs used in the present invention can comprise at least one PFR (which can comprise a flat-coiled or tubular coil assembly that contains tubing in a range of about 1/16 inch to ¼ inch inner diameter, and having a reactor volume in a range of between about 5 ml to 20 L, in particular, volumes ranging from 30 ml to 10 L, or more particularly, from about 50 ml to about 500 ml. The PFRs are made of a metal tubing of a fixed length that will allow for the volumes desired. In some aspects, the PFRs are jacketed in a metal alloy case which can allow for ease of insertion or removal from a chassis of a kit and allows the reactor to be heated or cooled with various means in contact with the jacket. FIG. 6 shows an aspect of a PFR unit operation module 100. A PFR unit operation module 100 can comprise a power supply 101, a temperature controller 102, one or more diverter valves 103 fluidically connected to the one or more fluidic connections 104, a heating and/or cooling element (not shown), a plug flow reactor 105, one or more pumps 106, a backpressure regulator 107, one or more vessels 108, and one or more mixers 109.

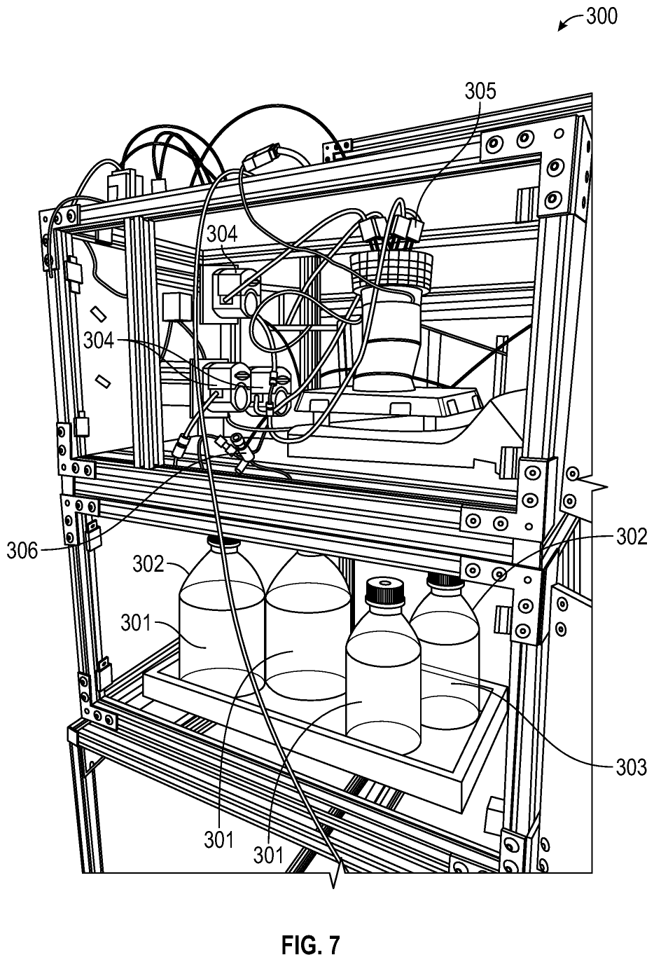

In another aspect, the reactor can be a CSTR contained in a CSTR unit operation module. In some aspects, a CSTR unit operation module 300 can comprise a power supply, a temperature controller, one or more diverter valves fluidically connected to the one or more fluidic connections, a heating/cooling element, a continuously stirred tank reactor, one or more pumps, a backpressure regulator, one or more vessels, and one or more mixers. In one aspect, shown in FIG. 7, the CSTR unit operation module 300 comprises a power supply (obstructed from view), a microelectronic controller (obstructed from view), starting materials 301, pumps 304, CSTR temperature probe 305, 4-port mixer (obstructed from view), start-up diversion valve (obstructed from view), diversion valve 306, and chemical products (drug precursor, crude drug product, etc.) output 303 in vessel 302.

When two or more continuous stir tank reactor modules are used in a system, the output of the first reactor can be used as a direct feed into the second or third, or more reactors as desired. Alternatively, it can be beneficial to employ a separator as discussed below to the intermediate stream from the first reactor for the removal of one or more of impurities, solvents or excess reagent, prior to the intermediate stream being introduced into the subsequent reactor.

### (b) Separator Modules

One aspect of the instant disclosure encompasses a separator module. In some aspects, a separator module described herein can comprise one or more separators. The separator can be used to at least partially separate one or more of impurities, solvents or excess reagents from the stream containing the intermediate or target chemical. The separator can involve processes including immiscible liquid separation, filtration distillation or the like.

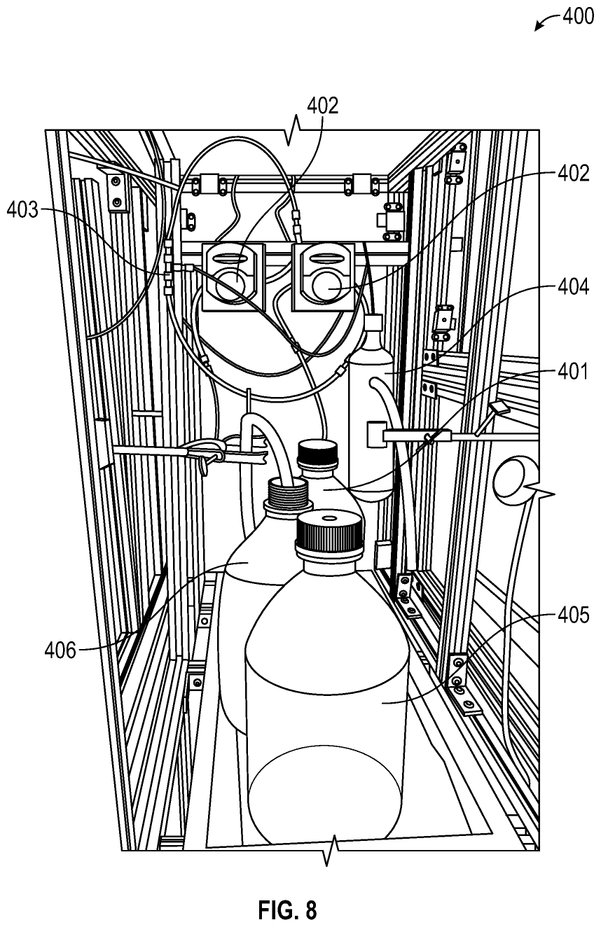

In one aspect, the separator can be a gravity separator contained in a gravity separator unit operation module. The gravity separator module can comprise a gravity separator and can further comprise a power supply, optionally, one or more diverter valves fluidically connected to the one or more fluidic connections, one or more pumps, a separator, one or more vessels, and one or more mixers. In one some aspect, shown in FIG. 8, the gravity separation module 400 comprises a power supply (obstructed from view), microelectronic controller (obstructed from view), input material vessel 401, pumps 402, T mixer 403, gravity separator 404, desired products vessel 405, and waste materials vessel 406. In some aspects, the gravity separator is a purely passive device, and could also include control elements, actuators, pumps, or sensors.

Following the reaction, in-line purification modules can separate impurities from the reaction product stream or remove excess reagents or solvents that can be incompatible with the subsequent reaction step(s). Purification can involve methods including distillation, membrane separation, nanofiltration, and extraction, which can be applied to the removal of impurities, separation of volatile components/solvents, isolation, and recycling of catalysts. Spectroscopic tools (e.g., near-infrared, mid-infrared, Raman, UV-vis, and NMR spectroscopy) can be used to monitor for and quantify the presence or disappearance of unwanted impurities, regents, or solvents as part of the automated system.

### (c) Crystallizer Modules

Another aspect of the instant disclosure encompasses a crystallizer unit operation module. Crystallization can be used for the separation as well as purification of a solid product. Crystallization occurs when the solubility of a solute of interest in solution is reduced by some means such that the solute/solvent composition reaches a state of super saturation and begins to precipitate out. Methods to reduce the solubility of the solute in the solvent include cooling, antisolvent addition, evaporation of the solvent, and precipitation of the solute of interest through chemical reaction, or a combination of these methods. The formation of solid product can be monitored by measuring the turbidity of the resulting suspension.

Continuous crystallization involves a crystallization module in which a solution of the chemical intermediate or product is continuously flowed into the module, and the slurry of the chemical with solvent or solvent mixture is continuously withdrawn from the module. In the crystallization unit, supersaturation is the driving force for nucleation and crystal growth. A high degree of supersaturation can accelerate the nucleation and growth rate and will consequently increase the total crystal surface in the crystallizer. Continuous crystallizers which can be used in the modules and systems of the present invention, include, but are not limited to, mixed-suspension mixed-product removal (MSMPR) crystallizers, plug-flow (PF) crystallizers, microfluidic crystallizers, Laminar shear crystallizers, Couette-Taylor crystallizers, fluidized bed crystallizers and forced circulation crystallizers.

A continuous crystallizer module can comprise one or more of an MSMPR crystallizer. A single-stage MSMPR crystallizer has only one tank. Multi-stage MSMPR crystallizers can employ a cascade of two or more MSMPR crystallizers, in which the outlet line from one crystallizer connects to the next crystallizer with a feed line. In comparison with single-stage MSMPR, multi-stage MSMPR can generate product with narrower crystal size distribution (CSD), use energy more efficiently, relieve fouling, give a greater throughput, increase mean crystal size and improve crystal purity.

A continuous crystallizer module can comprise one or more of a continuous tubular crystallizer. In a tubular crystallizer, the solution is fed at the inlet and moves through the tube. Crystallization is caused by supersaturation generated by cooling or anti-solvent addition, and the product crystals are withdrawn at the outlet. Depending on the operation mode, continuous tubular crystallization can be broadly classified as plug flow (PF) crystallization, segment flow crystallization, or continuous oscillatory baffled crystallization (COBC). PF crystallizers generally have a shorter residence time and can produce products with smaller size than MSMPR crystallizers. It will be understood that the inventive apparatus can comprise multiple crystallizers of differing or similar types fluidically connected in series.

Monitoring and control of the parameters and conditions for the crystallization modules is important to ensure that the desired purity of the product is achieved. For example, changes in solvent composition or temperature can result in decreased purification efficiency, decreased yield or changes in the polymorphic composition of the chemical product. Also, multiple factors have an impact on crystal size distribution, including but not limited to residence time, temperature, and impurities. In the continuous crystallization process, the general operating variables are temperature, residence time, and concentration/anti-solvent addition rate. The advantage of continuous crystallization is that operating parameters (temperature, residence time, concentration, etc.) can be constant in a steady-state condition. The overall objective of continuous crystallization process control is to stably produce crystals in accordance with the requirements.

The continuous crystallization processes can benefit from process analytical tools as they can give real-time feedback of the variations of the parameters to manage a robust control during the process. As part of the monitoring and control system, PAT measurements can be applied to obtain in situ information about the solution and/or slurry, which can be important for the control of the crystallization process. The crystallization process can be monitored by one or more of focused beam reflection measurement (FBRM), particle video microscope, attenuated total internal reflectance Fourier-transform infrared spectroscopy, attenuated total reflectance/ultraviolet spectroscopy and image-based measurements. The crystallization parameters, such as temperature, anti-solvent dosing rate, and cooling rate can be continuously monitored and adjusted to remain within the specified parameters. Other PAT, such as Raman IR, pH sensing, ultrasound measurement and similar technologies can be used in this and the other modules.

In particular, FBRM can be used for chord length determination, particle counting, and chord length distribution determination, and also for polymorphism determination. Chord length and chord length distribution can be translated into crystal size and CSD. Spectroscopic techniques such as ATR-FTIR and ATR-UV/vis can be used to monitor the concentration of solutes based on the correlation between the peak heights in the associated absorption spectrum and the concentration. Similarly, Raman spectroscopy can be used for polymorphism determination and for concentration monitoring.

In some aspects, after the pharmaceutically active agent has been crystallized, the crystals are granulated and blended with excipients in a series of solid-state operations in a formulator module.

### (d) Filters and Filtration Modules

Yet another aspect of the instant disclosure encompasses a filtration module. In some aspects, filtration of the solid product can be the next downstream process after precipitation or crystallization of the product of interest. In some aspects, after filtration, the crystals can be dried. The filtered product can be used in further processing, for example, in a formulator module, mixing the filtered product with excipients, capsule filling, or tablet pressing. A drier can be configured to at least partially remove moisture and/or other liquids from the remaining solid. Drying can involve evaporation of solvent, for example by heating and/or the reduction of the pressure of the surrounding environment.

The system can comprise one or more filtration and washing units. The module(s) for filtration and washing can comprise separate filtering (F) and washing (W) units or preferably combined in a single (F/W) unit in a module. The filtration and washing units have the capability of removing solvent from solids and slurries via pressure filtration, stirring, and overhead vacuum. The vessels used in these units can have heating capabilities and therefore can dry the filtered product and are known as filter/washer/dryer (FWD) units in the module. The F/W or FWD unit can have a stirring component, such as a metal stirrer blade, that allows the vessel to mix the contents. The F/W or FWD unit can be comprised of a mixing chamber, filter plate, vessel base, and lid. In some aspects, the mixing chamber can be constructed of a Hastelloy C-276 6-inch schedule 10 pipe. It will be understood by those of skill in the art that other chemically resistant piping or similar fluid transfer vessel can be adapted for use in the modules and kits of the present invention. The filter plate can be a sintered C-22 Hastelloy filter plate. The filtration plate can be removable in some aspects. It should be appreciated that in some aspects, there can be a welded connection between the filtration and washing unit and the filler plate.

In some aspects, the F/W or FWD units in the module comprise a Hastelloy™ chamber inserted into a polymer base and sealed with an O-ring. The base has at least one drain hole to allow either processed material or waste to exit the vessel. The side of the base has at least one thermocouple/thermistor for temperature control/temperature monitoring, although other means of temperature measurement could be used. For the FWD it is a thermocouple/thermistor for the heating loop, the filtration and washing unit has a thermocouple/thermistor for monitoring temperature. The lid of the F/W or FWD seals to the top of the Hastelloy™ mixing chamber with a gasket. In some aspects, different materials are used in the F/W or FWD units including different lids and gaskets materials. In some aspects, the gasket is compressed by tightening a plurality of swinging thumbscrew clamps. The lid is equipped with multiple connection ports for solvent dispensing, slurry transferring, a motor, overhead pressure or vacuum. In some aspects, to allow the user to see the process, the lid can comprise a viewing port. In one aspect the viewing port is made of ½″ borosilicate glass sealed with a gasket. In alternative aspects, the viewing port could comprise a wholly inclusive subset of mirrors, lights, and cameras to aid in determining the status of the interior of the vessel.

In some aspects, a motor or other actuator can be mounted onto a bracket and coupled to the stirrer blade. Depending on the actuator employed, protective or enclosing structures can be added. To protect the motor, a plurality of one, two, three, four, or more steel posts and custom protective cover can be added. In some aspects, two PTFE shaft seals are used between the lid and stirrer to ensure pressure and vacuum requirements. Since the vessel is pressurized a pressure relief valve and/or rupture disc is installed on the lid so that the vessel does not over pressurize during use. It will be understood that all the components of the reactor can be constructed from materials that meet the requirements of a desired process. The components can be constructed of the same or different materials based on the intended use of the reactor, and are known to individuals of skill in the art. Non-limiting examples of materials include metals, including but not limited to steel, metal alloys such as Hastelloy™ and Inconel™, stainless steel, aluminum, as well as plastics such as PTFE, pPFA or Teflon™, and polyetheretherketone (PEEK), ceramics, glass, and composites. In some aspects, it could be beneficial to construct the components from, or can comprise portions made of thermally conductive material or material that can withstand pressures that can accumulate in the process chamber. It is noted that, because reactions in the reactor system occur in the reaction compartment of the chemically and biologically inert liner, the reactor vessel, lid, or both can even be constructed from non-chemically and non-biologically inert material. Accordingly, a wider selection of materials, even non-chemically resistant material, can be used to construct a reactor.

In some aspects, one or more pumps are utilized for the transfer of reagents and solvents in and between the modules. In some aspects, the pumps can deliver a flow rate in the range of 0.9 μl/min to 90 ml/min but can be replaced with different style and size pumps if lower or higher flow rates are required depending on the phase state (liquid v. slurry) and the scale of throughput. Pumps are selected with various wetted materials based on the compatibility of reagent to be transferred. For example, pump wetting parts include, but are not limited to, FFKM, and PTFE. Reagents are drawn up through tubing feed lines of the pumps, into their respective flow meters or sensors, other PAT, and then go to either an inline heat exchanger or to a corresponding vessel. The pumps can be fixed in the module or mounted to a removable tray with the possibility for one up to eight pumps or more to be used in the system.

Pressure driven flow pumps are air pumps which can be used for transferring slurry between vessels. These pumps can deliver 0.1 to about 10 liters/min, including, for example, about 4.5 liters/min in one aspect, with enough pressure 1.5 bar (max) for transferring slurries across vessels such as transfer of a crude first product to a first CSTR module for washing and extracting solvent, and then into a second CSTR or FWD for further washing and drying the purified API. In some aspects, the pumps are housed on a left-siding mid panel of the first CSTR module, but it should be appreciated that the placement can differ. Alternatively, these pumps can be replaced with a gas supply that would provide enough pressure and flow to transfer slurries across more than one or more vessels. In either aspect using compressed gas or pumped air, valving is typically used to control pressure supplies to vessels, equalizing and venting when necessary.

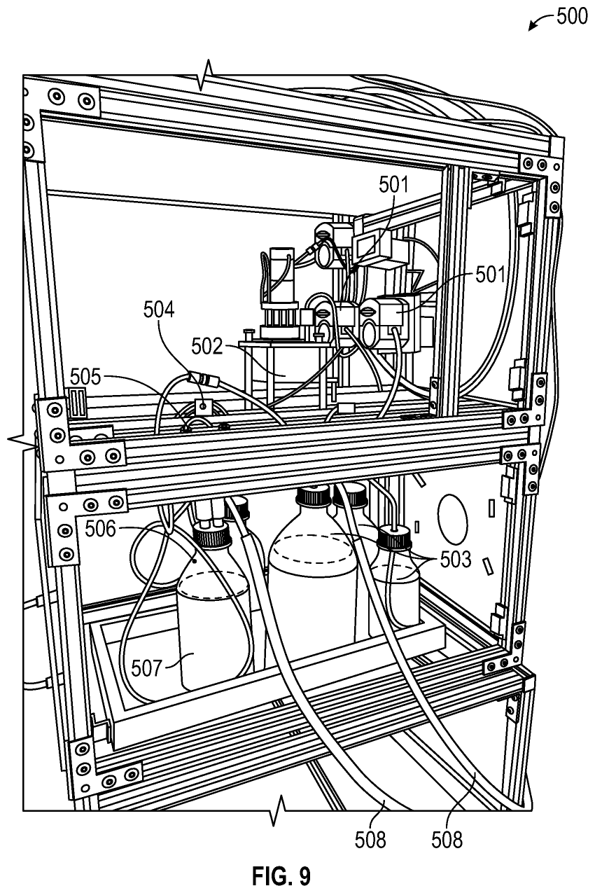

In one aspect, a filter/washer/drier module comprises at least one filter-washer-dryer (FWD) and further comprises a power supply, one or more diverter valves fluidically connected to the one or more fluidic connections, one or more pumps, one or more vessels, and one or more mixers. In one aspect, shown in FIG. 9, the FWD unit operation module 500 comprises a power supply (obstructed from view), microelectronic controller (obstructed from view), pumps 501, a FWD 502, input materials vessels 503, product diversion valve 504, vacuum release valves 505, waste materials vessel 506, product materials 507, and vacuum lines 508.

### (e) Evaporator Modules

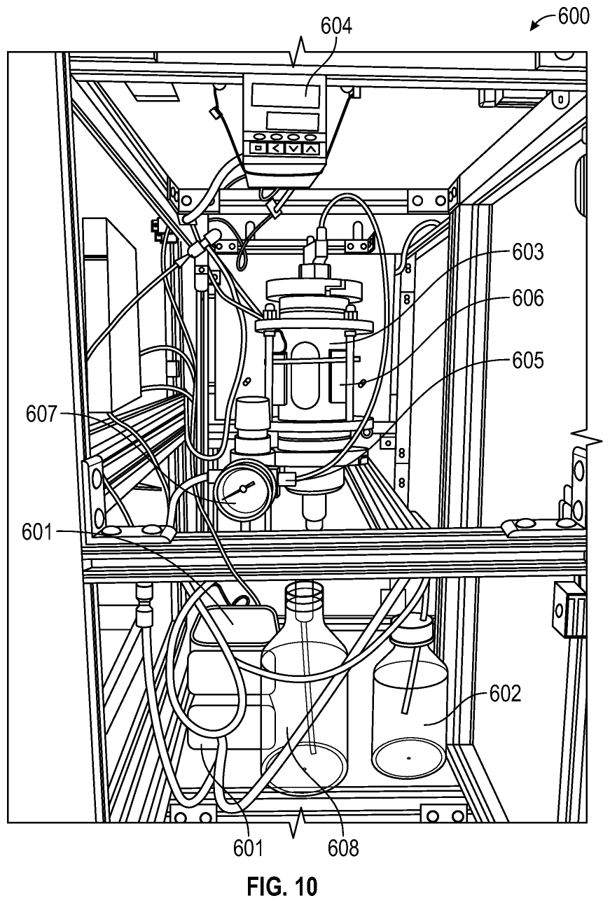

One aspect of the instant disclosure encompasses an evaporator module. In some aspects, an evaporator unit operation module comprises at least one evaporator and further comprises a power supply, at least one gas inlet and outlet, a heating element, a thermocouple, one or more diverter valves fluidically connected to the one or more fluidic connections, one or more pumps, a pressure regulator, an evaporation unit, and two or more vessels. In one exemplary embodiment, shown in FIG. 10, the evaporator unit operation module 600 comprises a power supply (obstructed from view), microelectronic controller (obstructed from view), pumps 601, input solution vessel 602, an evaporation vessel 603, thermocouple 604, a gas inflow port 605, a gas outflow port (obstructed from view), heating element 606, pressure regulator 607, and product output vessel 608. In alternative aspects, the evaporators used could comprise spray evaporators that, depending on the material to be evaporated, could eliminate the use of compressed gas, heat, and thermocouples.

### (f) Sterilizer Modules

Another aspect of the instant disclosure encompasses a sterilizer module. For active ingredients, product sterility is an important element for human patient safety. For instance, intravenous medicines should be substantially free of bacteria/viruses and other biological contaminants. Accordingly, a sterilizer unit operation module can comprise one or more components designed to remove/destroy bacteria and viruses, and to remove the pyrogenic materials from viruses or bacterial cell walls using sterilization methods known in the art. Non-limiting examples of methods of sterilizing active ingredients include ultraviolet (UV) radiation, gamma irradiation, autoclaving, and filtration through sterilizing-grade membranes. High-pressure processing and heat treatment are also common sterilization techniques employed in the pharmaceutical industry. The choice of sterilization method often depends on the chemical and physical properties of the active ingredient, as well as its compatibility with the sterilization process. For heat-sensitive compounds, for example, gamma irradiation or cold sterilization techniques can be more appropriate.

Although bacteria and viruses are often destroyed using heat and/or gamma irradiation, these methods can damage some active ingredients or other elements within a final drug product and are generally less preferred for use in the formulator modules provided herein. Components and strategies for aseptic processing and sterilization for use in the formulators include UV sterilization to destroy bacteria and viruses, filtration to eliminate contaminants, connectors to reduce introduction of biological contamination and tubing types, which for example can be replaced with each formulation run. In some aspects, a sterilization module comprises a UV radiation sterilizer.

UV radiation can be used for destroying bacteria and viruses. Specifically, UV-C (254 nm wavelength) can offer a lower-radiation dosage (i.e., safer for environment and human operators) that can also tunable based on the intensity and time in a smaller footprint of a sterilizer unit operation module. UV light can be activated inside a confined disinfection chamber through which a fluid path is conducted. The intensity of the UV radiation and the residence time of the fluid (flow rate) in the chamber ensures that the fluid exiting the chamber has been sufficiently sterilized. Although the size of standard medicine production facilities would not be conducive to the implementation of UV as a sterilization technique, the smaller form factor of a sterilizer module of the instant disclosure allows the use of UV as a sterilization technique. Additional methods of sterilization can be used in combination with the use of UV sterilization. Commercially available UV chambers (see, ClorDiSys Flashbox Mini UV-Chamber, for example) can be adapted for this use by creating a flow-through path for tubing to enable sterilization of the fluid housed within. This UV chamber can provide a dosage: 2000 μW/cm2 (60 mJ/cm2 per 30 second exposure), 30 second iterations, 2× UV-C 254 nm.

Sterilizing filtration can also be used in a sterilization module of the instant disclosure to ensure drug product safety. Microporous filtration effectively maintains sterility and prevents contamination, while avoiding the application of heat to potentially sensitive liquid samples. In some aspects, the sterilization module uses filtration through a membrane with 0.2 micron or smaller pore size removes biological contaminants, including bacteria, mold and yeast. Filter materials can be any compatible material known in the art for the sterilization of liquids, including nylon, polycarbonate, cellulose acetate, polyvinylidene fluoride (PVDF, Durapore® membrane), and polyether sulfone (PES). Particularly, polyvinylidene fluorides and polyether sulfones are low protein-binding materials without leachables. Polyether sulfones filters can be generally preferred for filtration due to their faster flow rate.

One aspect for sterilizing filtration can be provided by Millipore Optiscale 0.2 μm sterilizing capsule filters. These filters have polyether sulfone filter material and polypropylene body material with a 3.5 cm2 filtration area and 0.2 μm porosity. Due to the hydrophilicity of the filter material and its low porosity, it has a two-step priming procedure that involves wetting the filter by passing water through it, followed by opening of the vent port to release any residual air. These priming steps are preferably automated by attaching the side port to a two-way valve and inclusion of a 3-way valve downstream of the filter and redirecting the corresponding streams to waste.

### (g) Formulator Modules

The instant disclosure also provides modules/systems and methods for the production of formulations of active pharmaceutical ingredients (APIs) starting from the API and one or more inactive ingredients. A formulator can intake one or more API and at least one or more inactive ingredients (excipients) and can perform a series of steps to yield a composition (formulated drug product) which can be packaged for use in administration of the drug product. The formulator is incorporated into an on-demand continuous-flow synthesis apparatus for production of chemicals, and particularly for the on-demand production of pharmaceutical products.

Advantageously, a formulator of the instant disclosure can produce a formulated drug product to provide near instant access to reproducible final dosage forms. In some aspects, the formulation modules/system can produce liquid formulations including, for example, injectable and intravenous medicines. In some aspects, the modules/systems can produce a plurality of individual sterile injectable doses of drug comprising a specific API and excipient(s), which can be formulated on demand in a GMP and FDA acceptable manner.

In some aspects, the formulator is a self-contained formulator unit operation module that can be linked with other unit operation modules of the instant disclosure in a kit system programmed to manufacture an API and formulate the API for ultimate use by individuals. In other aspects, a formulator can be configured in a standalone kit system where the API is produced separately using a kit system of the instant disclosure programmed to manufacture the API. Kit systems can be as described in Section I herein above.

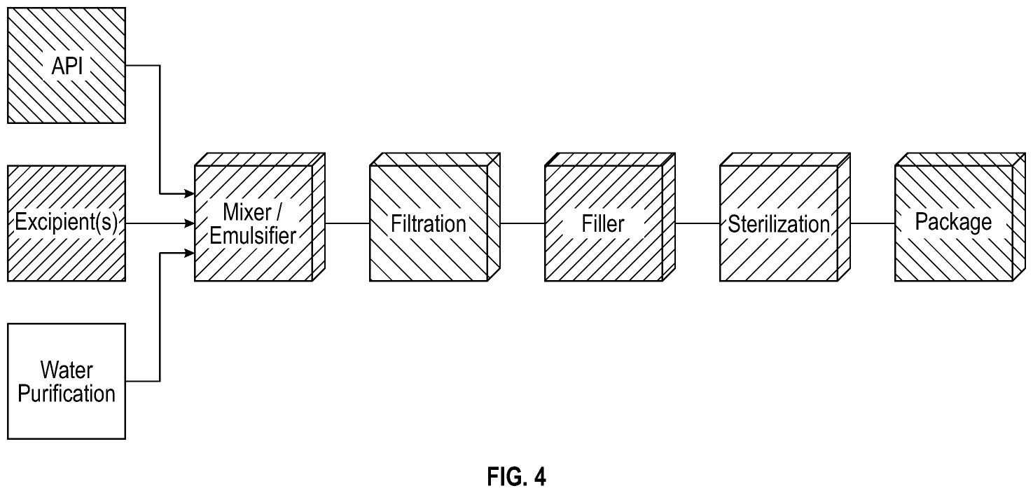

FIG. 4 summarizes the basic elements of a formulator module or a formulator kit. These components include mixers, pumps, filters, fillers, sterilizers, and packagers. The order of the events post-mixing can vary depending on the formulation approach for intravenous medicines.

In some aspects, the formulator comprises a system for the formulation of API into a liquid dosage form. In some aspects, the formulator is an automated intravenous medicine formulation system. The systems can be capable of producing a plurality of individual sterile injectable doses comprising a specific API and excipient(s), which can be formulated on demand, when needed, and in a GMP and FDA acceptable manner.

In Some aspects, the formulator comprises a system for formulation of API into a liquid, gel or similar dosage form, wherein the liquid dosage form is an intravenous bag or container which can be administered to a patient via an I.V. line in a clinical setting.

In other aspects, the formulator comprises a system for the formulation of solid pharmaceutical dosage forms. The solid dosage forms include compressed tablets and filled capsules.

The formulation modules/systems can be automated, comprising a mixer/emulsifier; filtration; filler; sterilizer; and packager and packaging and labeling. In some aspects, the system includes additional sample probes, such as pH and spectroscopic probes (FT-IR, UV, Raman, etc.).

In some aspects, a formulator module/kit system comprises: a) at least one source of water for injection or a water purification module/module component to produce water for injection from non-sterile water source; b) at least one (first) container comprising an active pharmaceutical ingredient (API) which can be manufactured using other modules and kit systems in a continuous sequence; c) at least one (second) container comprising one or more excipients for mixing with the API; d) at least one chamber for mixing and/or emulsifying the API with the excipient(s); e) at least one filter and/or sterilizer or at least one filtration and/or sterilization unit operation module or unit operation component for removing or reducing viable or non-viable bio burden from drug product; f) a packager comprising a module or module component capable of dispensing the sterilized mixture of API and excipient into a second container suitable for holding an intravenous drug mixture; and g) a fluid transferring module or module component for transferring fluid between different unit operation modules or unit operation components that can comprise one or more of tubing, pumps, valves, fittings, and aseptic connectors. The module or module component of a) can be fluidically connected to the container of b) and container of c) and/or chamber of d); the container of b) can be fluidically connected to the chamber of d); the container of c) can be fluidically connected to the chamber of d); the chamber of d) can also be fluidically connected to at least one filtration or sterilization module or module component e), filtration or sterilization module or module component e) can also be fluidically connected to packager f), and all the fluidic connections can be part of the fluid transfer module or module component g).

In some aspects, the containers are flexible, such as IV bags. The IV bags can have a one or more inlet/outlets. In some aspects, the API and the excipients can be solid or granular or can be liquid, or combinations thereof. In some aspects, the mixer is a chamber into which the API and excipient are pumped into and stirred. In some aspects, the one filter, or filtration means, is an inline filter or membrane filter. In some aspects, the sterilizer can be 0.2 μm filter, a UV-C irradiation source, or both. In some aspects, the fluidic connections are comprised of tubing. In some aspects, the packager is a dispenser capable of dispensing the sterilized mixture into a final IV bag or into individual IV vials for injection.

In some aspects, the formulator processes can start from purified, GMP-grade API. The unit operation modules and/or components for the formulation of an API to formulated drug product can include:
pH probe (inline use will require calibration protocol to be defined)
PAT probes
Sterilized Water for Injection (either prepared in unit or provided)
Scale (potentially for quantitative validation)
Mixing Chamber
Homogenizer (for emulsion-based drug products)
Aseptic processing and sterilization
EV inspection

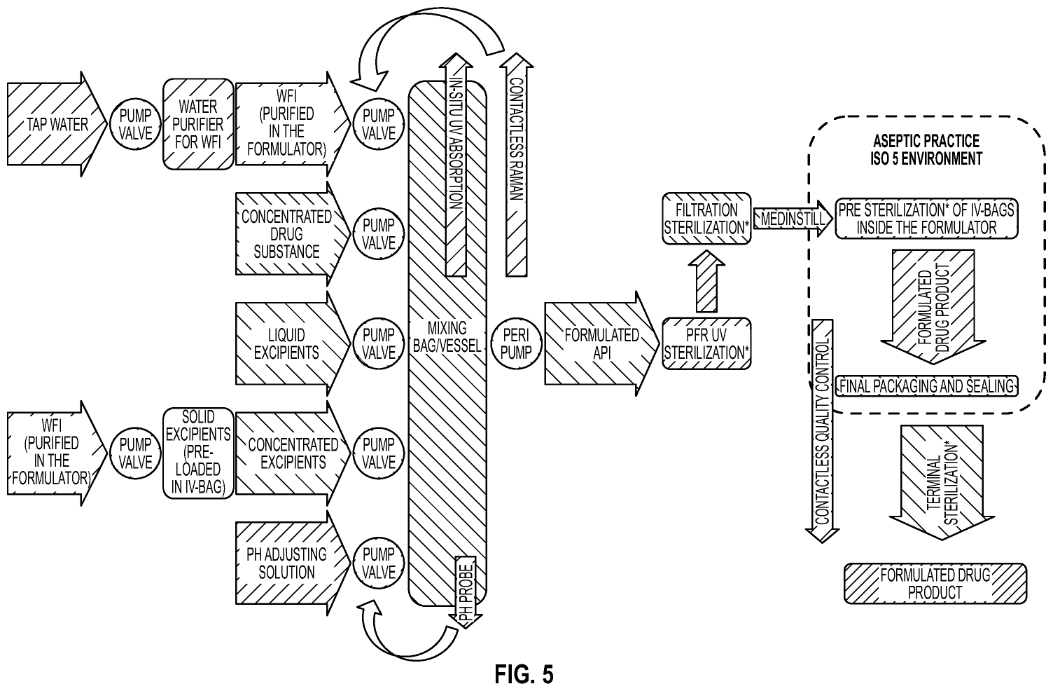

FIG. 5 demonstrates the generalized process flow to create IV medicines from API input. It will be understood by those of ordinary skill in the art that different API can require modification to this workflow. In an aspect, the process begins by dissolving the API created in a PoD or other upstream kit and inactive ingredients in a sterile solvent, which is preferably water, but can include other pharmaceutically acceptable solvents. This dissolution step has options that include separate dissolution of API and excipient(s) followed by mixing. Alternatively, in another aspect, API and excipient(s) can be combined, followed by the addition of water. In the field, the sourcing of water can be an important aspect of formulation preparation.

Once API and excipients are combined in a homogenous solution, the API solution can then follow a number of possible paths through different modules. These include a path that passes through filtration and sterilization modules prior to a fill and finishing module. Alternatively, the material can proceed via filtration module into the fill and finish module, followed by a terminal sterilization module. Where possible, terminal sterilization can be performed. The path is often dependent on the properties of the final drug product and can be defined by the formulation for each API. The fill and finish modules' activities are contained within the dotted box on the right side of FIG. 5.

Excipients can be supplied in containers, including bags, cartridges, bottles, or the like. Alternatively, WFI can be provided separately, for example in a separate container or sourced on-site. The system can be defined to work with many different input combinations. The mixture can be then fed from the other modules into a mixing chamber where pH or electrolyte composition is adjusted. Other unit operations, such as mixers and separators, for example, can be included post-mixing chamber to yield emulsions. In some aspects, the unit operations can be performed by unit operation modules as described herein.

Measuring, pumping, and controlling fluids, and particularly water, are important elements in the process to produce formulated medicines in the continuous or batch type formulator module. In one aspect, mass measuring devices, such as load cells can be used to augment flow-rate monitoring, because mass is a reliable measurement. The formulator can benefit from the accurate measurement of each ingredient to ensure safe production of medicines. Load cells provide an appealing system because these are lower cost compared to commercial scales and have the potential to be more accurate and traceable. The load cells can be initially calibrated based on measured weight of an analytical scale and the calibration can be linear over a wide range of weights and can remain constant over many days. Load cells can also be evaluated in conjunction with a bag mixer, thus consolidating two-unit operations into one. In an alternative aspect, electromagnetic type weighing systems using the electromagnetic force compensation (EMFC) principle can be used.

Mixing involves a container that can withstand rigorous mixing. In some aspects, bags can be used as vessels for mixing of the produced API with excipients. A bag mixer can be based on a mechanism that translates the rotational motion of an overhead stirrer into a linear motion that induces turbulent vortical mixing. In an aspect, a bag inside a mixing chamber can be mixed by the actuation of paddles, that alternate pushing on the sides of the bag and/or against the chamber and causing agitation of the solution within the bag. The pumps, used for the movement of fluid through the formulator module can be any appropriate pump, including peristaltic pumps displacement pumps, syringe pumps, piston pumps, plunger pumps, screw pumps and reciprocating pumps. Peristaltic pumps can be selected for the processing because pumping can occur without having the pump elements contact the liquids and tubing used within the pump head is easily discarded after each production run. In some aspects, pumps in a formulator module are peristaltic pumps.

For intravenous medicines, product sterility is an important element for human patient safety. Intravenous medicines should be substantially free of bacteria/viruses and other biological contaminants. Accordingly, the formulator can comprise one or more components designed to remove/destroy bacteria and viruses, and to remove the pyrogenic materials from viruses or bacterial cell walls. Alternatively, formulations produced by a formulator module of the instant disclosure can be sterilized in a dedicated sterilization module fluidically and functionally connected to the formulation module. Sterilization and sterilization modules can be as described in Section II(f) herein above.

The connection and disconnection of components from the formulator module should allow for the maintenance of a sterile environment. The connectors can be re-usable, multi-use connections. In some aspects, installed sterile connections can be used after the UV chamber and filter to keep the environment and contents within the remaining downstream process sterile.

The components of the formulator module can be connected by tubing. In some aspects, a single-use train of disposable tubing, bags, connectors, and filters enables an aseptic environment within the formulator. Furthermore, this single-use paradigm can mitigate risks associated with cleanability and “clean in place” requirements from one production run to another. The tubing material can be selected from, for example, platinum-cured silicone, Tygon™, C-Flex™ and Gore™ tubing, or the like. The selection of tubing can be specific to the medicine formulations, to ensure compatibly with the formulation API, excipients and/or processing.

### (h) Additional Kit Components?

Flow meters. Flow meters are used for the real time monitoring of flow rates during continuous operation and can be part of the system PAT. Various flow meters can be used depending on the pump from which the flow rate monitoring is required e.g., difference flow meters can be used for slower or faster flow rates, fluid compatibility and viscosities. The flow meters transmit data through electrical signals, including, but not limited to utilizing RS485 communication and connectors, with a fast response time down to 40 ms and can be mounted with custom brackets for ease of replacement or calibration testing.

Valves. Solenoid valves can be installed in the systems due to their tight seal (30 psi outlet port, 60 psi inlet port), fast transitioning between ports, and excellent corrosion resistance. The wetted parts of the valves are entirely PTFE, but other chemically inert, resistant or compliant materials can be used. The valves that are integrated in the modules are not limited to 3-way or 2-way configurations. These valves can serve a variety of fluid transfers including water and product collection and can be connected to tubing using push-to-connect or other such fittings.

Four-way Solenoid Air Directional Control Valves can be mounted onto a manifold to pneumatically control one or more slurry valves. In some aspects, a manifold is connected directly to the air regulator where the pressure is set to a particular pressure, for example, 60 psi, in accordance with the slurry valves pressure parameters. The Solenoids operate on DC voltage and can be operated at 12 or 24 VDC and are completely isolated from product contact. In some aspects, there is a manifold with four ports. The materials can be composed of zinc and ethylene propylene diene monomer (EPDM) rubber, and can contain dienes such as ethylidene norbornene (ENB), dicyclopentadiene (DCPD), and vinyl norbornene (VNB) or neoprene gasket, but it should be appreciated that similar materials can also be used.

### (i) Ancillary Components

other components for functioning of the unit operation module including vessels operable for use to comprise chemical precursors, reagents, and/or solvents necessary for the synthesis of the chemical composition of interest; vessels for the collection of reaction products and waste streams and the chemical composition of interest; one or more transducers electronically connected to one or more of the unit operation component; one or more fluidic connections affixed to the chassis, wherein each fluidic connection fluidically connects a unit operation module to another unit operation module or other (source of chemicals, pumps, containers, sensors, etc.

The continuous-flow on-demand kits and systems of the present invention, can comprise one or more reagent holding/dispensing containers, continuous-flow unit operation modules such as chemical synthesis modules and/or one or more separation, crystallization, filtration, wash and/or formulation modules, additionally comprise automated detection systems and methods for monitoring reagents, products and processing parameters and automated control systems and methods for controlling processing conditions and parameters. Automated detection systems can include detection of chemicals and conditions within a container, such as a reaction vessel or fluid conduit, which can be automated such that it has functionalities including: the system can keep track of the type and amount of material inside each container, material analysis methods and process parameter monitoring are contactless, both qualitative and quantitative detection, reduced operator error, and quality control of the formulated drug product. automated, reconfigurable synthesis/purification machine to produce multiple drugs.

### A. Contactless Detection

One aspect of the instant disclosure encompasses modules/kit systems and methods for touchless monitoring, analysis and/or detection of chemicals in a container in general, and particularly in connection with on-demand chemical production.

The terms “touchless” or “contactless,” in the context of this disclosure, refers to a measurement technique that does not come into direct contact with the substance being measured. Such touchless measurement techniques are applied through the wall of the container, without making direct contact with the contents of the container. A measurement technique can be “on-line” or “in-line.” On-line measurement involves diverting a portion of a stream containing the analyte(s) to be measured from the manufacturing process or container for measurement, which sample can be returned to the process stream. For in-line measurement, the sample is not removed or diverted from the process stream or container.

The disclosure provides modules, kit systems, and methods for the touchless detection, quantification, monitoring and/or analysis of chemicals in a container. The modules, kit systems, and methods can be used as part of an on-demand batch method apparatus, or on-demand continuous-flow apparatus for the production of chemicals, and particularly of pharmaceutical products. As part of a continuous-flow process, the raw material(s) and solvents are continuously charged into the system and the product is continuously discharged from the system during the duration of the process.

Continuous-flow manufacturing systems benefit from integrated touchless real-time monitoring of parameters of the chemical reagents and products, including the identity, quantity, processing conditions and control. Touchless measurement of these parameters translates to increased safety due to reduced manual handling of materials, reduced risk of spills, and reduced risk of intermediate or product contamination. Continuous manufacturing systems further benefit from integrated processing and control based on these measurements to further improve safety, ease of operation, reduce processing times and improve product quality.

The modules, kit systems, and methods for detection of chemicals contained within a container or reaction vessel which can be automated such that it has the following functionalities:
The modules and kit systems can keep track of the type and amount of material inside each container;
Volume detections methods are contactless;
Material analysis methods are contactless;
QR code for tracking of containers and material and/or RFID for tracking of containers, material, and usage;
Potential for tampering detection;
Reduced operator error in using the wrong material for a process;
Quality control of the formulated drug product; and
Both qualitative and quantitative detection.

The process monitoring and control systems, including the touchless measurement system and the processor(s) and/or controller unit(s), can monitor the status of a reaction or transformation and actively manipulate parameters to maintain a desired state. For continuous-flow systems, touchless measurements can provide process data that can be correlated to the underlying process steps or transformations. Such data can relate to the progress of a chemical reaction, for example by chemically identifying and/or measuring the concentration of process starting materials, intermediates, products or by-products. These data can be useful for process monitoring, control of process parameters, end point determination, and the like, particularly when they relate to product and process quality. The monitoring provides real-time indication that the process steps or transformations are within predetermined process parameters. The touchless measurement of input materials and parameters, processing parameters, and output or endpoint parameters promotes consistent quality of the output materials from any processing step and the final product. Particularly when used as part of an automated control system, the touchless measurement of these parameters allows real time or near real time monitoring of process attributes for adjusting process parameters to optimize reaction conditions. Accordingly, the automated maintenance of the parameters, ensured through continuous assessment during manufacture, provides a real time quality assurance to validate the process and reflect product quality.

In some aspects, the touchless detection systems of the present invention can be used to set the quality control parameters for API such as cisatracurium besylate. In some aspects, the tests, methods, and acceptance criteria which are specified in USP43-NF38 for cisatracurium besylate for injection and in ICH guidelines are included in Table 10.

TABLE 10
Test Methods and Acceptance Criteria for Cisatracurium Besylate Injection

| | | ODP | |
|---|---|---|---|
| | | method | |
| Test Parameter | Method | status | Acceptance Criteria |
| Identification | HPLC | TBD | The retention time of the major |
| | | | peak in the sample corresponds |
| | | | to that of the standard solution, |
| | | | as obtained in the Assay |
| | IR | TBD | The IR spectrum for the |
| | USP <197> | | sample matches the spectrum |
| | | | of the reference standard. |
| Assay | HPLC | TBD | 90.0%-110.0% |
| Related Substances: | | | |
| Besylate | | | N/A** |
| cis-Quaternary acid | HPLC | TBD | NMT 4.3% |
| (R)-N-Methyllaudanosine | HPLC | TBD | N/A |
| (R)-Laudanosine | HPLC | TBD | 4.0 |
| cis-Quaternary methyl ester | HPLC | TBD | N/A |
| and benzyl alcohol | | | |
| cis-Quaternary alcohol | HPLC | TBD | NMT 5.0% |
| Benzaldehyde | HPLC | TBD | N/A |
| R-trans-R′-trans-Atracurium | HPLC | TBD | N/A |
| R-cis-R′-trans-Atracurium | HPLC | TBD | N/A |
| trans-Monoquaternary | HPLC | TBD | N/A |
| compound | | | |
| trans-Monoacrylate | HPLC | TBD | N/A |
| cis-Monoquaternary | HPLC | TBD | N/A |
| compound | | | |
| cis-cis-Triester analog | HPLC | TBD | N/A |
| cis-Monoacrylate | HPLC | TBD | NMT 2.5% |
| Any Individual Unspecified | HPLC | TBD | NMT 0.2% |
| degradation product | | | |
| Total degradation | HPLC | TBD | NMT 14.4% |
| pH | <791> | AM-017 | 3.0-3.8 |
| Bacterial Endotoxins Test | <85> | TBD | NMT 8.17 Endotoxin Unit/mg |
| Sterility | <71> | TBD | Conforms |
| Particulate Matter in Injections | <788> | TBD | ≥10 μm: NMT 6000 |
| | | | Per container |
| | | | ≥25 μm: NMT 600 |
| | | | Per container |
| Uniformity of Dosage Units^{§} | <905> | TBD | AV ≤ L1 |
| Appearance* | Visual | AM-016 | Clear, colorless to slightly |
| | <1790> | | yellow or greenish yellow |
| | | | solution |
| Container Content for | <697> | TBD | The volume is NLT |
| Injections | | | the nominal volume |
| | | | in the case of |
| | | | containers examined |
| | | | individually. |

HPLC = High Performance Liquid Chromatography;
GC = Gas Chromatography;
NMT = Not More Than;
USP = United States Pharmacopeia;
NLT = No Less Than
‡ Of the label claim
*Do not report or include in total degradation products, because this is controlled in the drug substance.
**Due to counterion and not to be reported or included in total degradation products.
^{§}“The requirements for dosage uniformity are met if the acceptance value of the first 10 dosage units is less than or equal to L1%” - USP <905>
AV = M − XA + ks
AV = acceptance value
M = 98.5% if XA < 98.5%
XA = average of individual contents (expressed as %)
k = 2.4 (for n = 10)
s = standard deviation of individual contents
L1 = 15

The touchless detection systems of the present disclosure can allow for continuous monitoring of reagents, intermediates and/or reaction products without contamination of the materials by being in contact with sensors or probes as part of an on-demand continuous-flow synthesis apparatus for production of chemicals. The chemicals detected can be pharmaceutical precursors, crude API, purified API, finished API formulations, impurities, small molecules and amino acids, peptides, proteins, glycoproteins, and biologics. This allows rapid throughput and minimizes cycling times due to the lack of the need to clean the sensors.

Another aspect provided by this disclosure includes the rapid detection of pharmaceutical products in the field, as well as their quantification to ensure proper dosages are being provided. The pharmaceutical product can be within a container, i.e., closed packaging such as a bottle or an IV bag, and the pharmaceutical product is measured while inside the unopened container using a touchless measurement technique. The measurement of the product in a container can be applied as part of the on-demand system to assess the final product quality. Alternatively, the measurement of the product in a container can be applied through the transparent container using a hand-held instrument without sampling of the material. Raman spectroscopy is the most common technique due to its high specificity and ease of sample presentation, although NIR and MIR instruments are also available and appropriate for certain applications (e.g., drug product excipients). The sample spectrum can be compared to a standard spectrum or library for conformance of identity assessment. These instruments are also in widespread use for pharmaceutical counterfeit detection.

The containers used in the systems of the present invention can be any chamber, vessel, bottle, conduit, tubing, and the like, that comprises an internal volume suitable for receiving, retaining and/or transferring the sample. The container can be comprised of a rigid or flexible material. Containers can be comprised of translucent or transparent materials and are chemically resistant or non-reactive materials. Container materials can include one or more of glass, polyethylene, high-density polyethylene (HDPE), low density polyethylene (LDPE), polycarbonate, polymethyl methacrylate (PMMA), polyethylene terephthalate (PET), polyvinyl chloride (PVC), polypropylene (PP), liquid silicone rubber (LSR), fluorinated ethylene propylene (FEP), perfluoroalkoxy alkanes (PFA), and the like.

When the basis of the measurement in the inventive systems relies on the use of electromagnetic radiation, the container will be at least partially constructed of a material that allows electromagnetic radiation to penetrate the container for detection, monitoring and/or analysis of the substance(s) within the container. In other aspects, the container can comprise a non-transmissive material, such as metal, carbon fiber or other composite, or non-transmissive plastic, and further comprise a window of transmissive material through which the measurement is made.

The containers used in the systems of the present invention comprise a chamber defining an internal volume suitable for receiving, retaining and/or transferring a fluid sample. The container can additionally comprise one or more ports for the introduction, transfer or removal of the fluid contents, or other chemical components. The container can be, for example, in the form of bottles and IV bags. In other aspects, the container is a continuous reaction vessel or a fluidic path connecting various unit operations. The continuous reaction vessel can be, for example, a tube reactor, a plug flow reactor (PFR), or a continuous-stirred tank reactor (CSTR).

The touchless measurement system(s) of the present invention can comprise instruments adapted to measure, for example, quantity (i.e., volume, weight, etc.), analyte identity and/or concentration, flow rate, temperature, pressure, turbidity, color, reagent use, reagent verification, and product verification.

The touchless measurement used in the systems of the present invention can be performed using spectroscopic analysis, ultrasonic detection, or optical detection.

Reagent verification, product verification, analyte identity and concentration analysis within the container used in the systems of the present invention can be performed using electromagnetic radiation spectroscopy, such as UV/Vis, NIRF, FTIR, and Raman.

Spatially offset Raman spectroscopy (SORS) is a variant of Raman spectroscopy that allows chemical analysis of the contents of a container used in the systems of the present invention, even beneath an obscuring surface. A SORS measurement makes two or more Raman measurements; one at the source and one at an offset position of typically a few millimeters away. The two spectra can be subtracted using a scaled subtraction to produce two spectra representing the subsurface and surface spectra.

The touchless measurement system(s) of the present invention can be adapted to track fluid volume and/or flow rate within the container using ultrasound or camera and machine vision. Ultrasonic fluid level measurement can be performed, for example using GL Sciences Liquid Level Sensor Reservoir Accessories. Non-limiting examples of suitable ultrasonic flow rate sensors include SonoFlow® C0.55|Ultrasonic Clamp-On. Liquid volume and flow rate tracking can also be monitored using computer vision and pre-trained instance segmentation using a convolution neural network (CNN) algorithm or related software method. Using this method, the current volume in a transparent container used in the systems of the present invention can be monitored by computer vision based on the pixel area of liquid to vessel. Computer vision can be used to track the fill line of the liquid contents of a transparent container.

The container used in the systems of the present invention can include one or more surfaces configured to display one or a plurality of optical marks. The optical marks can be placed on an exterior surface of the container and/or on an interior surface of a transparent container. The optical marks can include two-dimensional optically encoded marks, QR codes, barcodes, and the like. In conjunction with a camera, or other optical sensor used in the systems of the present invention, the marks can dynamically convey data such as the volume, change in volume and flow rate.

For example, in the system of the present invention, to measure the fluid-level in a container, a QR code can be positioned on a surface of the container such that the level of the internal fluid bisects the mark as observed by a scanning system comprising an imaging sensor, such as a camera. The QR codes can have positioning information within the structure of the mark. For example, the large square features of the QR code can provide reference positions within the mark itself. In some aspects, one purpose of showing the code was to make sure that if the liquid surface is partially blocked, the volume can still be determined.

Additionally, the container can have a QR code, or other optical mark, to provide a unique exterior identification for the container and its contents. The QR code provides a means of tracking containers and materials and reduce the opportunity for operator error in using the wrong material for a process.

As an alternative, RFID can be used for tracking of containers, material, and usage in the systems of the present invention. Use of an RFID tag on the container makes it possible to store information of the container, including but not limited to its serial number, size, material, stored material and amount, usage time, used amount, user accessed, location used, and chemical composition. This information can be updated each time that the container is placed and used in a system.

In some aspects, the systems of the present invention comprise a scanning system. A scanning system uses a light source, such as a laser, which is directed to the optical marks, optionally by a lens or other optical components. The scanner can function by repetitively scanning the light beam in a path or series of paths across the optical marks. Scanning systems can also include a sensor or photodetector which detects light reflected from the optical marks. A portion of the reflected light is detected and converted into an electrical signal, and electronic circuitry or software decodes the electrical signal into a digital representation.

In some aspects, in the systems of the present invention, the temperature of the container can be monitored using a touchless temperature sensor. Non-limiting examples of suitable touchless temperature sensors include infrared temperature sensors. Exemplary commercially available temperature sensors include Melexis Technologies NV part number MLX90614KSF-ACC-000-TU-ND.

In some aspects, the systems of the present invention can measure turbidity. Turbidity is an optical measurement that indicates the presence of suspended particles in the container contents. Turbidity can be measured by shining light through the container contents and using a photo detector to measure light scatter. Suitable devices can include Endress Turbimax CUS50D, CUS51D, CUS52D.

In some aspects, the sensor(s) of the touchless detection system(s) of the present invention can be electronically coupled to one or more processors and controller units as part of the continuous-flow synthesis apparatus, either as a stand-alone unit or part of a distributed network of apparatuses.

To ensure acceptable and reproducible outcomes for the chemical product, consideration is given to the quality attributes of reagent materials and solvents for each process step. The identity of raw materials can be confirmed upon receipt and/or prior to their use in the manufacturing process using the touchless measurement provided herein. Reagent containers can be marked with QR codes, barcodes, or other optically encoded marks, for ready identification by an optical scanner. The process of reagent verification is preferably automated and confirms that the proper reagents are loaded into the module(s) before initiation of the chemical reaction sequence. Reagent identification can additionally or alternatively be assessed or verified by the touchless spectroscopic methods provided herein and comparison to a standard for the reagent.

Following verification, the continuous-flow process is initiated. In continuous reactions, raw materials, and solvents (if used) are continuously charged into the reactor, and the intermediate or product is continuously discharged from the reactor throughout the duration of the process. The reactor can be, for example, a tube reactor, a plug flow reactor (PFR), or a continuous-stirred tank reactor (CSTR). As part of the touchless monitoring system, the touchless measurements can be applied to the reactor to provide real-time monitoring of process parameters to ensure that the chemical reaction progresses within specified limits, thus contributing to process efficiency, selectivity, yield and safety. Process variables, such as temperature, pressure, concentration, and rate of reagent or solvent addition can be adjusted in an adaptive response to the real time, or near real time, touchless measurements. Temperature and pressure can be monitored using thermocouples, infrared sensors, and optical pressure sensors, respectively. Spectroscopic measurements including near-infrared, mid-infrared, Raman, and UV-vis spectroscopy, can be used to monitor for the presence or disappearance of functional groups during the synthesis. By monitoring the specific functional groups, qualitative trending or quantitative assessment of the reaction component levels is achieved. Additionally, by integrating automated, real-time process control, real-time data can be acquired for process monitoring and applied to process control for ensuring product quality. This approach provides improved real-time control of the reaction progress ensuring the reaction parameters remain within specifications. For example, identification of functional groups of certain molecules can be performed with IR and monitoring the characteristic band for carbonyl groups, etc.

Following the reaction, in-line purification can separate impurities from the reaction product stream or remove excess reagents or solvents that can be incompatible with the subsequent reaction step(s). The separation can involve methods including distillation, nanofiltration and extraction, which can be applied to the removal of impurities, separation of volatile components/solvents, isolation, and recycling of catalysts. Touchless spectroscopic tools (e.g., near-infrared, mid-infrared, Raman, UV-vis, and NMR spectroscopy) can be used to monitor for and quantify the presence or disappearance of unwanted impurities, regents, or solvents.

Crystallization can be used for the purification and/or isolation of the chemical product. Upon addition of a counter-solvent/ anti-solvent, the formation of solid product can be monitored by measuring the turbidity of the resulting suspension, during formulation of an API, as excipients get mixed.

### III. Pharmacy on Demand (PoD) Units

In accordance with another aspect, the present invention provides distributed manufacturing systems, termed “Pharmacy on Demand (PoD)”™ units to produce and provide pharmaceutical precursor molecules, and/or active pharmaceutical ingredients (API) and/or finished pharmaceuticals directly to one or more subjects in need thereof, within minutes to weeks of manufacturing. As used herein, the term “PoD unit” can refer to a kit system assembled and programmed to make a single product, such as precursor API, API, or finished drug product. It can also refer to a system of kits that can produce multiple precursor APIs, APIs, or finished drug products. It will be understood by those of ordinary skill in the art that in some aspects, there will be a distributed network of PoD units which could be within a single location, or in multiple locations. The locations can be within miles of each other or regionally around a country or around the world. It will be understood by those of ordinary skill that the PoD units or kits can be deployed in very remote locations, such as in ships, submarines, or spacecraft, as long as there is power, precursors and space for the apparatus.

### IV. Methods

Continuous-flow manufacturing systems benefit from integrated real-time monitoring of parameters of the chemical reagents and products, including the identity, quantity, processing conditions and control. Measurement of these parameters can be direct or indirect/touch or contactless. Contactless measurement of these parameters translates to increased safety due to reduced manual handling of materials, reduced risk of spills, and reduced risk of intermediate or product contamination. Continuous manufacturing systems further benefit from integrated and/or automated processing and control based on these measurements to further improve safety, ease of operation, reduce processing times and improve product quality.

The individual manufacturing process for small molecule therapeutics can be comprised of separate and/or linked steps: Precursor and/or Active Pharmaceutical Ingredient (API) Synthesis, Drug Substance Purification, and Drug Product Formulation. The Synthesis step can generate the crude material of a precursor or API of a therapeutic through the utilization of a sequence and/or individual unit operation steps.

### (a) Chemical Process Design

The present invention provides one or more methods for making a chemical composition using the kit systems disclosed herein comprising: a) determining the number and type of modules necessary to synthesize a chemical composition of interest and the sequence in which the modules should be fluidically and electronically connected and the necessary reagents and precursors needed; b) obtaining the modules of a) and fluidically and electronically connecting them to each other in the sequence identified in a); c) programming the at least one master system controller to perform the synthesis of the chemical composition of interest using the one or more modules of a); d) adding all of the reagents and precursors to the vessels of the module as determined in step a) and f) using the kit system to prepare the chemical composition of interest.

In an aspect, the inventions provides a) selecting a chemical composition of interest to be synthesized; b) determining the number and type of modules necessary to synthesize the chemical composition of interest and the sequence in which the modules should be fluidically and electronically connected and the necessary reagents and precursors needed; c) obtaining or having obtained the modules of b) and fluidically and electronically connecting them to each other in the sequence identified in b); d) programming the system controller to perform the synthesis of the chemical composition of interest using the one or more modules of b); e) adding all of the reagents and precursors to the vessels of the module as determined in step b) and f) activating the kit system to prepare the chemical composition of interest.

In aspects or the invention, a chemical synthesis of a chemical of interest further comprises one or more of the following steps: optionally, verification of the one or more chemical reagents or precursors necessary for the synthesis of the chemical of interest; optionally dissolving one or more precursors or chemical reagents in one or more solvents; introducing one or more precursors and/or chemical reagents, optionally in one or more solvents, into a chemical reactor; mixing the one or more precursors and/or chemical reagents in the reactor, optionally in the presence of heating or cooling; discharging the product(s) of the reaction from the reactor; optionally, separating the reaction product(s) from solvent(s), impurities, and/or excess reagent(s); optionally, recycling solvent, excess reagent and/or reaction product to the reactor; optionally, purifying the reaction product through membrane separation, filtration, extraction distillation, crystallization, etc.; and optionally, drying the reaction product. It will be understood by those of ordinary skill in the art, that each of the above steps can be repeated jointly or severally depending on the chemical being synthesized.

Once a synthetic route is developed, the process and operating parameters can be locked into a computer stored sequence or program recipe. In some aspects, a crude product output can then be purified according to targeted impurity profile specifications in additional steps.

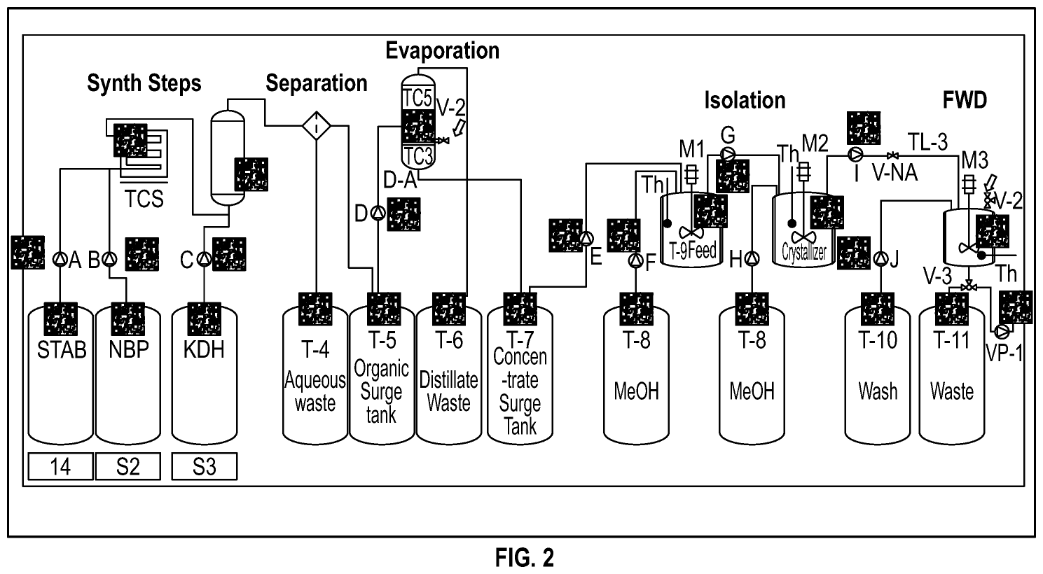

Once the synthetic and purification step sequences are defined, the next step in the program-generation workflow is defining the unit operations of a chemical composition manufacturing process. FIG. 2 represents a Piping and Instrumentation Diagram (PID) of an example set of unit operations comprised of the defined synthetic and purification step sequences. A PID describes the equipment that will go into the modules and defines the module number and type. In the aspect of FIG. 2, the PID has synthetic step(s), separation, evaporation, isolation, and FWD.

The corresponding kits can be pre-assembled with the appropriate unit operation modules and ancillary components, such as reactors, pumps and valves. Each module can be tagged with an identifying article, utilizing a mechanical, visual, electronic, or passive/active RF data delivery strategy, including, but not limited to, a bar code, QR code, RFID, Bluetooth tag (e.g., Tile™ or AirTag™), blockchain, and near field communication (NFC), to ensure the correct module is assembled in the kits. Instructions can be written as to how the kits can be configured in the central frame containing at least one system controller. After the modular kits for a system are constructed, system readiness checks can be initiated. An executable procedure can now be run on the system controller to produce the target compound or composition of interest.

### (b) Reagents and Reagent Introduction

To ensure acceptable and reproducible outcomes for the target chemical product produced using the systems and methods disclosed herein, consideration is given to the quality attributes of reagent materials and solvents for each process step. The identity of raw materials can be confirmed upon receipt and/or prior to their use in the manufacturing process using the touchless measurement provided herein. Reagent containers can be marked utilizing a mechanical, visual, electronic, or passive/active RF data delivery strategy, such as QR codes, barcodes, or other optically encoded marks, for ready identification by an optical scanner. In other aspects, the containers can have RFID, Bluetooth tag (e.g., Tile™ or AirTag™), blockchain, and near field communication (NFC) for reagent identification. The process of reagent verification is preferably automated and confirms that the proper reagents are loaded into the module(s) before initiation of the chemical reaction sequence. Reagent identification can additionally or alternatively be assessed or verified by the touchless spectroscopic methods provided herein and comparison to a standard for the reagent.

Following verification, the continuous-flow process is initiated. In continuous reactions, raw materials, and solvents (if used) are continuously charged into a reactor, such as in a reactor module, and the intermediate or product is continuously discharged from the reactor throughout the duration of the process. The reactor in the module can be, for example, a tube reactor, a PFR, STR, or a CSTR. As part of the monitoring and control system, measurements can be applied to the one or more reactors in the module to provide real-time monitoring of process parameters to ensure that the chemical reactions progress within specified limits, thus contributing to process efficiency, selectivity, yield, and safety. Process variables, such as temperature, pressure, pH, concentration, and rate of reagent or solvent addition can be adjusted in an adaptive response to the real time, or near real time, measurements using Process Analytical Technology (PAT). PAT can be used to monitor various physical aspects of the synthetic process. For example, temperature and pressure can be monitored using thermometers, thermocouples, infrared sensors, and pressure sensors, respectively. Spectroscopic measurements including near-infrared, mid-infrared, Raman, and UV-vis spectroscopy, can be used to monitor for the presence or disappearance of functional groups during the synthesis. By monitoring the specific functional groups, qualitative trending or quantitative assessment of the reaction component levels in the modules is achieved. Additionally, by integrating automated PAT, real-time process control, real-time data can be acquired for process monitoring and applied to process control for ensuring product quality. This approach provides improved real-time control of the reaction progress ensuring the reaction parameters remain within specifications. For example, identification of functional groups of certain molecules can be performed with IR and monitoring the characteristic band for carbonyl groups, etc.

### (c) Process Analysis and Control

Analytical sensors and probes can provide information and data on critical process parameters and critical quality attributes in the modules and kit systems of the instant disclosure. In-line, at-line, and on-line analytics are utilized to monitor the process and the units themselves. These include but are not limited to chemical, electrochemical, colorimetric, calorimetric, spectroscopic, optical. PAT includes the design, analysis, and control of pharmaceutical manufacturing processes and enables quality by design to ensure product quality. PAT can be comprised of at-line, on-line and in-line components, including but not limited to Raman, FTIR, NIR, UV-Vis, NMR, HPLC, and GC. Process parameters that can be monitored include pH, temperature, conductivity, pressure, and flow rate. As an example of PAT, scales can be used to monitor flow rates for the feed tanks and holding tanks. In some aspects, the units use a BBA242 Metro Toledo™ scale due to its compact size, load capacity (7.1 Kg), affordability, and its readability of 0.1 gram. It should be appreciated that similar scales can be used for monitoring. The scale transfers data across RS232, which allows the software to calculate the mass flow rates of the vessels. Other types of scales with various data connections can be used. Monitoring occurs both in the individual unit as well as at the central remote monitor.

The scales can have a stainless-steel platform and can be kept clear from the walls of the modules so that the readings are accurate as well as prevent any potential grounding issues.

In accordance with an aspect, the present invention provides distributed manufacturing systems to produce and provide pharmaceutical precursor molecules, and/or active pharmaceutical ingredients (API) and/or finished pharmaceuticals to one or more subjects in need thereof.

The modules and the operational units inside the modules can be controlled and monitored using a central controller unit (e.g., computer system, associated software and user interface) as part of the master system controller. The central control unit can thus be used for setup of module sequence (i.e., manufacturing process) and allow for verification of correct installation of disposable process components, monitoring, automation, process control and generation of electronic batch records for one or more individual modules and preferably, an entire module sequence (e.g., the entire manufacturing process). For example, the status of a particular module can be readily discerned and tracked (e.g., clean, dirty, in process, assigned to a specific process, etc.) and the flow of process intermediates and materials into, between and out of modules and/or areas of a manufacturing facility can also be monitored. Monitoring can be accomplished via one or more sensors.

It will be understood by those of skill in the art that in some aspects there can be a central master system capable of monitoring multiple PoD machines of the present invention. The central system can be comprised of multiple monitoring sites and the PoD machines can be comprised of multiple modules. In these aspects, there is a centralized unit monitoring and coordinating between the various machines. In some aspects, there are remote hubs that connect to the remote monitoring system(s) wherein the remote hubs monitor and coordinate with the modules.

The central master system can be comprised of multiple monitoring sites and the PoD machines can be comprised of multiple modules. In aspects, there is a system of units. In these aspects, there is a centralized master system controller monitoring and coordinating between the various machines. In some aspects, there are remote hubs that connect to the remote monitoring system(s) wherein the remote hubs monitor and coordinate with the modules.

In other aspects, there is a programmable logic controller to allow for the remote terminal unit, regional hubs, and PoD machines to communicate. In aspects, the programmable logic controller has automation systems, quality control systems, and can also comprise artificial intelligence features which allow for improvements in processing in real time. In some aspects, explicit logic decisions and less intense machine learning models can be used here. Options for those decisions include suggesting that the operator make adjustments in real time, acting as an offline informational system, and acting as a digital shadow or twin

Some aspects of the invention also utilize centralized and/or remote electronic monitoring, control, automation and data record production and storage for a manufacturing batch process using a central controller (for example). Process automation can be used to reduce the number of manual operations, resulting in a reduction of operator errors and an increase in the operability, efficiency and/or the reliability of the system.

In some aspects, there is a human-machine interface (HMI) allowing for real-time status and monitoring of the miniature manufacturing machines. The HMI can preferably have a visual display of data and be able to track production time, trends, and any other number of metrics. The HMI is able to make adjustments in real-time based on inputs, results, and/or any set parameters by an administrator/operator.

In accordance with another aspect, the present invention provides remote central control systems electronically in communication with distributed manufacturing systems to produce and provide pharmaceutical precursor molecules, and/or active pharmaceutical ingredients (API) and/or finished pharmaceuticals directly to one or more subjects in need thereof.

In accordance with another aspect, the present invention provides remote central control systems electronically in communication with distributed manufacturing systems to produce and provide pharmaceutical precursor molecules, and/or active pharmaceutical ingredients (API) and/or finished pharmaceuticals directly to one or more subjects in need thereof, wherein said remote central control systems include artificial intelligence features.

Some aspects of the invention also utilize centralized and/or remote electronic monitoring, control, automation and data record production and storage for a manufacturing batch process using a central controller (for example). Process automation can be used to reduce the number of manual operations, resulting in a reduction of operator error and an increase in the operability, efficiency and/or the reliability of the system.

In some aspects, the present invention comprises methods for programming the modules for individual target molecule synthesis including, the following steps: a) defining a sequence of chemical steps for synthesis of the molecule from defined precursors and reagents; b) defining sequence of purification steps for separating the synthesized target molecule from reagents and solvents; c) defining a set of modular “kits”, including reagents and equipment components to be used in the steps of a) and b); d) defining one or more configurations of the “kits” of c) to build systems used to make the target molecule; and e) running the assembled system using the kits of c) and the systems of d) to synthesize the target molecule.

In some aspects, the present invention comprises methods for programming the modules for individual target molecule synthesis including, the following steps: a) defining a sequence of chemical steps for synthesis of the molecule from defined precursors and reagents; b) defining sequence of purification steps for separating the synthesized target molecule from reagents and solvents; c) defining a set of modular “kits”, including reagents and equipment components to be used in the steps of a) and b); d) defining one or more configurations of the “kits” of c) to build systems used to make the target molecule; and e) testing the system for production of the target molecule by running the assembled system using the kits of c) and the systems of d) to synthesize the target molecule. In some aspects, the methods can further comprise the step f), reconfiguring a) and b) and then testing the system again.

An example remote control user interface is displayed in the included figures herein. According to some aspects of the invention, there are monitored unit components for the distributed manufacturing units as described more fully below.

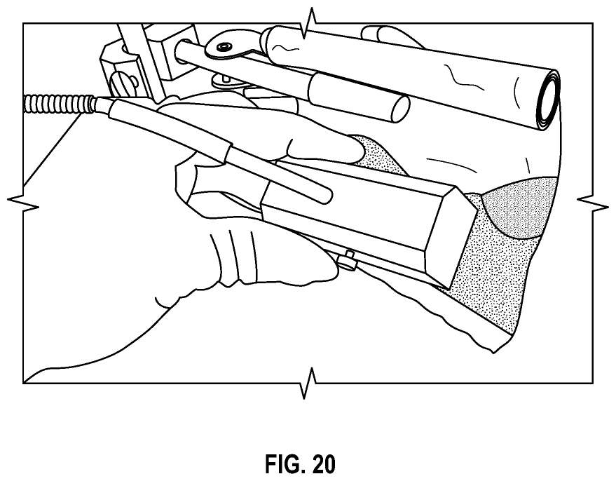

With reference to FIG. 18, one of a plurality of computer systems in the form of a computer 210 is shown. Each of the individual units as well as the central control in the manufacturing system includes a computer 210. As understood by aspects of the present invention, components shown in dashed outline are not part of the computer 210 but are used to illustrate the exemplary aspect of FIG. 20. Components of computer 210 can include, but are not limited to, a processor 220, a system memory 230, a memory/graphics interface 221, also known as a Northbridge chip, and an I/O interface 222, also known as a Southbridge chip. Alternative single chipsets for memory/graphics interface and I/O interfaces can also be used. The system memory 230 and a graphics processor 290 can be coupled to the memory/graphics interface 221. A monitor 291 or other graphic output device can be coupled to the graphics processor 290. In an alternative aspect, a graphics interface can not be required, as the computing device could run in a “headless” operating mode. In other aspects, system storage could be handled by an external SCADA or similar system, while the local controller just makes decisions.

A series of system busses can couple various system components including a high-speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 can be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets can be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media can comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and can accessed by the computer 210.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired, or fiber optic connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random-access memory (RAM) 232. The system ROM 231 can contain permanent system data 243, such as identifying and manufacturing information. In some aspects, a basic input/ output system (BIOS) can also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 can couple the system bus 223 with a number of other buses 226, 227 and 228 that couple a variety of internal and external devices to the computer 210. A serial peripheral interface (SPI) bus 226 can connect to a BIOS memory 233 containing the basic routines that help to transfer information between elements within computer 210, such as during start-up.

In some aspects, a security module 229 can be incorporated to manage various security modules. In some aspects, a security module 229 combines programmatic logic control, edge control, and cyber security features on local units, regional hubs, and on a remote terminal unit. The security modules can ideally incorporate a universal I/O interface. The security module is ideally a self-contained enclosure with all the necessary utilities required to conduct manufacturing to ensure absolute fidelity of the contents. The module is temperature and humidity controlled.

In an alternative aspect, a super input/output chip 260 can be used to connect to a number of ‘legacy’ peripherals, such as disk 252, keyboard/mouse/buttons 262, and printer 296, as examples in addition to the security modules. The super I/O chip 260 can be connected to the I/O interface 222 with a low pin count (LPC) bus, in some aspects. The super I/O chip 260 is widely available in the commercial marketplace.

In one aspect, bus 228 can be a Peripheral Component Interconnect (PCI) bus, or a variation thereof, can be used to connect higher speed peripherals to the I/O interface 222. A PCI bus can also be known as a Mezzanine bus. Variations of the PCI bus include the Peripheral Component Interconnect-Express (PCI-E) and the Peripheral Component Interconnect-Extended (PCI-X) busses. The former having a serial interface and the latter being a backward compatible parallel interface. In other aspects, bus 228 can be an advanced technology attachment (ATA) bus, in the form of a serial ATA bus (SATA) or parallel ATA (PATA) or USB or USB-C.

The computer 210 can also include other removable/non-removable, volatile/nonvolatile computer storage media. By way of example only, FIG. 20 illustrates a hard disk drive 240 that reads from or writes to non-removable, nonvolatile magnetic media. Removable media, such as a universal serial bus (USB) memory 252 or CD/DVD drive 256 can be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media, discussed above and illustrated in FIG. 20, provide storage of computer readable instructions, data structures, program modules and other data for the computer 210. In FIG. 20, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum; they are different elements within the computer 210. A user can enter commands and information into the computer 210 through input devices such as a mouse/keyboard 262 or other input device combination. Other input devices (not shown) can include a microphone, joystick, game pad, satellite dish, scanner, or the like. These and other input devices are often connected to the processor 220 through one of the I/O interface busses, such as the SPI 226, the LPC 227, or the PCI 228, but other busses can be used. In some aspects, other devices can be coupled to parallel ports, infrared interfaces, game ports, and the like (not depicted), via the super I/O chip 260.

The computer 210 can operate in a networked environment using logical connections to one or more remote computers, such as a remote computer 280 via one or more network interface controllers (NIC) 270. The remote computer 280 can be a personal computer, a server, a router, a network PC, a peer device, or s system controller on another network, or other common network node, and typically includes many or all of the elements described above relative to the computer 210. The logical connection between the NIC 270 and the remote computer 280 depicted in FIG. 2 can include a local area network (LAN), an Ethernet-based network, a wide area network (WAN), or both, but can also include other networks. Such networking environments are commonplace in offices, enterprise-wide computer networks, intranets, and the Internet.

### Definitions

Unless defined otherwise, all technical and scientific terms used herein have the meaning commonly understood by a person skilled in the art to which this invention belongs. The following references provide one of skill with a general definition of many of the terms used in this invention: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991). As used herein, the following terms have the meanings ascribed to them unless specified otherwise.

When introducing elements of the present disclosure or the preferred aspects(s) thereof, the articles “a”, “an”, “the” and “said” are intended to mean that there are one or more of the elements. The terms “comprising”, “including” and “having” are intended to be inclusive and mean that there may be additional elements other than the listed elements.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant, both in relation to the other endpoint, and independently of the other endpoint.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

The terms “cake” and “filter cake” are used interchangeably and refer to the bed of solids (insoluble material) deposited on the filter plate after or during filtration of a slurry.

As various changes could be made in the above-described cells and methods without departing from the scope of the invention, it is intended that all matter contained in the above description and in the examples given below, shall be interpreted as illustrative and not in a limiting sense.

### EXAMPLES

All patents and publications mentioned in the specification are indicative of the levels of those skilled in the art to which the present disclosure pertains. All patents and publications are herein incorporated by reference to the same extent as if each individual publication was specifically and individually indicated to be incorporated by reference.

The publications discussed throughout are provided solely for their disclosure before the filing date of the present application. Nothing herein is to be construed as an admission that the invention is not entitled to antedate such disclosure by virtue of prior invention.

The following examples are included to demonstrate the disclosure. It will be understood by those of skill in the art that the modules, kits, systems, and methods of the present invention do not need to operate within a POD unit and can be used in conjunction with any other unit operation module in a synthetic process. It should be appreciated by those of skill in the art that the techniques disclosed in the following examples represent techniques discovered by the inventors to function well in the practice of the disclosure. Those of skill in the art should, however, in light of the present disclosure, appreciate that many changes could be made in the disclosure and still obtain a like or similar result without departing from the spirit and scope of the disclosure, therefore all matter set forth is to be interpreted as illustrative and not in a limiting sense.

### Example 1. Plug Flow Reactor (PFR) Module

A plug-flow reactor module was assembled having generally, the following components: a PFR (a flat-coiled assembly, with aluminum shell housing having a reactor volume of 15 ml, using ⅛ inch PFA tubing); two milliGAT® LC pumps connected to two input reagent reservoirs via tubing and 3-way valves; a product reservoir connected to the outlet of the reactor and connected to a FTIR detector and then connected to a waste reservoir; a flexible heater assembly having a controller, and the heater in contact with the shell of the PFR and a thermocouple also in contact with the same shell to measure temperature in the PFR; backpressure regulators connectively attached to the pumps; a power supply, USB I/O and attached to a fixed frame. This is generally a universal set of components that enable a single module to perform unit operations in support of multiple different precursors and API. FIG. 6 shows an annotated picture of the Plug Flow Reactor module.

### Example 2. Continuous Stirred Tank Reactor—Ambient Module

FIG. 7 shows an annotated picture of the CSTR module. In this example the module has a power supply and microcontrollers which are electrically connected to the milliGAT® pumps. Reservoirs for starting reactants and reagents are connected to the pumps with diverter valves for waste, and reservoirs for products and waste are connected to the CSTR unit, which is a BuchiGlas Miniclave Steel, Type 3, 200 mL, with a PTFE insert. Pressure and temperature sensors are incorporated into the module along with a heater unit and stirring plate for stirring the contents of the reactor with a magnetic stir bar. The reactor is fitted with temperature and pressure sensors and a heat source. The sensors and heater are all connected to microcontrollers which electronically communicate with a PC through an I/O interface.

### Example 3. Continuous Stirred Tank Reactor—Universal Module

The module for the Universal CSTR was assembled as follows. The module has a power supply and microcontrollers which are electrically connected to the milliGAT® pumps. Reservoirs for starting reactants and reagents are connected to the pumps with diverter valves for waste, and reservoirs for products and waste are connected to the CSTR unit, which is a 400 ml aluminum vessel with a sanitary clamp assembly, with a PFA insert, and PTFE sanitary clamp gaskets. Pressure and temperature sensors are incorporated into the module along with a heater unit and stirring plate for stirring the contents of the reactor with an impeller connected to 12V DC gearmotor drive assembly. The reactor is fitted with temperature and pressure sensors and a heat source. The sensors, drive assembly, and heater are all connected to microcontrollers which electronically communicate with a PC through an I/O interface.

### Example 4. Gravity Separator Module

The module for the gravity separator was assembled having the following components: a blown glass gravity separator of dimensions between about 130 to about 175 mm long and between about 38 to about 51 mm outer diameter (Ace Glass, Inc.), and optionally can include a membrane separator apparatus (Zaiput, Inc.); peristaltic pumps connected to one or more reservoirs for solvents via ⅛ in i.d. tubing which connects fluidically via valves to one or more other modules and to the separator apparatus; wherein the separator apparatus is fluidically connected to two or more outlets for the product and waste. FIG. 8 shows an annotated picture of the Gravity Separator module.

### Example 5. Filter Washer Dryer (Crystallizer) Module

The module for the Universal filter-washer-dryer was assembled having the components as follows: upper and lower motor mounting plate attached to a stirring motor (Pololu Gearmotor); the CFWD generally comprising a 350 ml chamber with trap door, upper and lower seal rings, upper and lower filter plates; air controller and valves, heating blanket, and temperature and pressure sensors. The CFWD device of the instant invention comprises a vessel defining a process chamber, a vessel base, a filter plate disposed across the flow path of a liquid into and out of the vessel, a vessel lid, an agitator assembly, a drain port in the vessel base for outflowing the liquid phase of the slurry filtered through the filter plate, and optionally a solids discharge port in the vessel operable to remove the crystal fraction of the slurry retained by the filter plate. It will be recognized that the CFWD device can further comprise additional components or parts known to individuals of skill in the art suitable for the intended function of the crystallizer. The CFWD is fluidically connected to reagent and waste reservoirs via PFA tubing and are also fluidically connected to piston pumps and valves which are electronically in communication with a power source and series of microcontrollers controlled via a PC through an I/O interface. FIG. 9 shows an annotated picture of the Filter Washer Dryer (Crystallizer) module.

### Example 6. Evaporator Module

The module for the evaporator was assembled having the components as follows: an evaporation chamber between about 100 ml to 500 ml with a sanitary clamp lid, an atomizer body and tip assembled within the chamber, the chamber having a collection base and a product exit fitting, the chamber also optionally having a sight glass allowing visual inspection of the process inside the chamber. The evaporator is fluidically connected to reagent and waste reservoirs via PFA tubing and are also fluidically connected to piston pumps and valves which are electronically in communication with a power source and series of microcontrollers controlled via a PC through an I/O interface. The evaporator module also has a gas supply and the gas (typically N2, but can be other gasses) is connected to a gas inlet port on the evaporator, and can leave the evaporator via an exit port through PFA or other material tubing, and the inlet port also is connected to a pressure transducer to measure the headspace pressure in the evaporator, which is electronically connected to a PC through an I/O interface. FIG. 10 shows an annotated picture of the Evaporator Module.

### Example 7. Kit System Design: Kit System for Producing Diisopropylhydroxybenzoic Acid (DIHA)

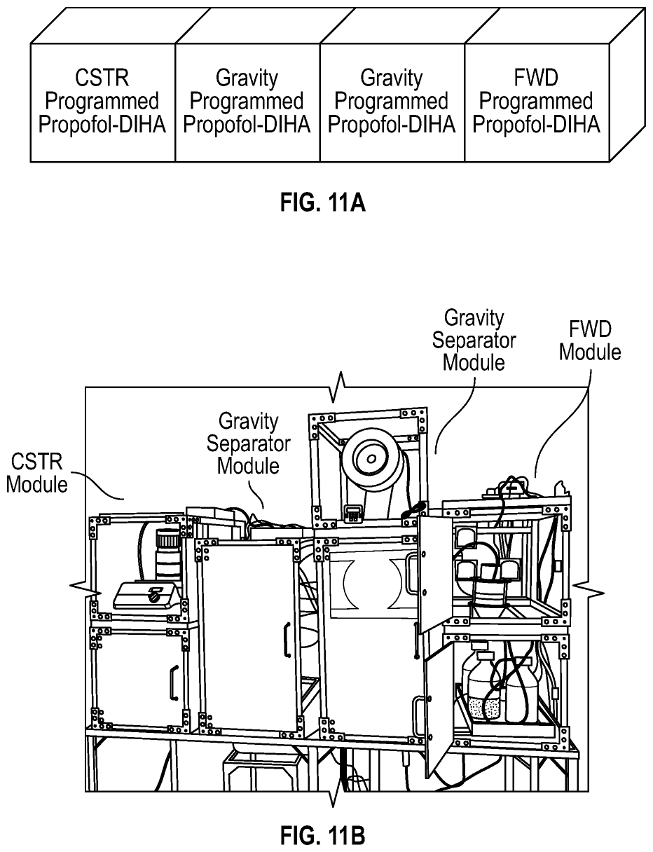

FIG. 11 shows a picture of the kit system for producing the diisopropylhydroxybenzoic acid (DIHA) precursor for the API propofol and one possible reaction scheme this system performs. The first step combines a mixture of 4-hydroxybenzoic acid/isopropanol with sulfuric acid in a CSTR module. The reaction output is then mixed with toluene and the toluene phase is collected and the aqueous acid phase transferred to waste. The toluene phase is then extracted with a base and the aqueous phase transferred to a filter-washer system where subsequent acid addition results in precipitation of the DIHA product. The material is then washed and dissolved into 2-ethoxyethanol and transferred to a collection vessel as a ready-made solution for transfer to the propofol kit system. The fourth step in the process is shown in the picture behind the open door on the far right-hand side. The sequence of process steps that take place is shown in the first column in Table 11.

TABLE 11

| | | Pumps | | | | Motor | Manual Valves | | | Vacuum | |
|---|---|---|---|---|---|---|---|---|---|---|---|
| | | Devices | | | | | | | | | |
| | | 1 | 2 | 3 | 4 | 1 | 1 | 2 | 3 | 1 | 1 |
| | | Set points | | | | | | | | | |
| Process step/ | | 5 | 5 | 150 | 30 | volt | NO/ | NO/ | NO/ | on/ | on/ |
| Description | | ml/min | ml/min | ml/min | ml/min | 10 | NC | NC | NC | off | off |
| charge FWD | time 0 | 1 | 1 | 0 | 0 | 1 | 0 | 0 | 0 | 0 | 0 |
| slurry formation | time 30 | 0 | 0 | 0 | 0 | 1 | 0 | 0 | 0 | 0 | 0 |
| slurry settle | time 40 | 0 | 0 | 0 | 0 | 0 | 0 | 0 | 0 | 0 | 0 |
| filter liquids | time 41 | 0 | 0 | 0 | 0 | 0 | 0 | 0 | 0 | 1 | 0 |
| vent waste | time 44 | 0 | 0 | 0 | 0 | 0 | 0 | 1 | 0 | 0 | 0 |
| close vent and | time 45 | 0 | 0 | 1 | 0 | 0 | 0 | 0 | 0 | 0 | 0 |
| add wash solution | | | | | | | | | | | |
| wash mix | time 56 | 0 | 0 | 0 | 0 | 1 | 0 | 0 | 0 | 0 | 0 |
| filter liquids | time 50 | 0 | 0 | 0 | 0 | 0 | 0 | 0 | 0 | 1 | 0 |
| vent waste | time 53 | 0 | 0 | 0 | 0 | 0 | 0 | 1 | 0 | 0 | 0 |
| close vent add | time 54 | 0 | 0 | 0 | 1 | 0 | 1 | 0 | 0 | 0 | 0 |
| ethoxyethanol | | | | | | | | | | | |
| dissolve product | time 55 | 0 | 0 | 0 | 0 | 0 | 1 | 1 | 0 | 0 | 0 |
| offload product | time 59 | 0 | 0 | 0 | 0 | 0 | 1 | 0 | 0 | 0 | 1 |
| reset | time 62 | 0 | 0 | 0 | 0 | 0 | 0 | 0 | 0 | 0 | 0 |

This process description is now step one of a five step approach to mapping the process into a digitizable format (the rest of the table). Step 2 is to define the devices that require automation as shown in the second row. Set-points are then defined (Step 3) along with the duration of that set-point (Step 4). Step 5, the final step, is to define the sequence for each activity and cycle loop for continuous production. This table is then imported into a laboratory information management system (LIMS) such as a LabView-based digital environment, that is referred to as the sequencer.

The sequencer and the basic algorithm of the underlying code that is executable is based on the data inputs provided. In some aspects, the first step comprises the sequencer using the header associated with the table to define the devices (voltages and other relevant automation settings will already be preloaded—drivers). In the next step, the sequencer then defines the set points, duration, and sequence of events. Once these tasks are complete, the sequencer, next sends these updated drivers to controllers to initiate the system. The controllers act as input/output boards sending the voltage information out to the unit operation components in the modules and capturing voltages from sensors embedded in the modules of the kit system. The sequencer is a core element of the multi-layered, scalable [digital] architecture. The center image shows the architecture where central systems are the top layer and kit systems are the second layer. The third layer are the modules that comprise the kit systems and include components (transducers) that are further subdivided. Once a kit system is programmed the recipe is saved by the system and can be recalled.

### Example 8. Propofol Precursor DIHA Production

In accordance with another aspect the present invention provides one or more processes for producing the precursor diisopropylhydroxybenzoic acid by alkylating 4-hydroxybenzoic acid on strong acidic conditions with isopropanol.

In some aspects, the users can introduce starting materials and wash solvents and control the system via a software program. The kit system is fitted with an exhaust system so that DIHA could be produced anywhere, anytime in principle. As shown in FIGS. 11A and 11B, an exemplary aspect of the kit system comprises a CSTR (upper left) module, Gravity Separator 1 (middle left, separates acid rich waste from toluene rich product phase) module, Gravity Separator 2 (middle right, extracts product from toluene into basic water) module and finally the filter-washer module where solid product is collected, washed and redissolved in 2-ethyoxyethanol.

In one example, the propofol DIHA production run lasted for 12 hours, starting from initiation of the production sequence until the last API precursor offload. Monitoring during production identified that the temperature on the CSTR moved above tolerance so a portable fan was used to maintain favorable CSTR temperatures.

TABLE 1
Propofol DIHA Precursor Production Measures

| Production Measure | Results | |
|---|---|---|
| Starting Materials Consumed | 15.82 | kg |
| 4-Hydroxybenzoic Acid 1.5M in Isopropanol | 0.41 | kg |
| Sulfuric Acid (Neat, 18M) | 5.97 | kg |
| Toluene (Neat, 9.4M) | 6.95 | kg |
| NaOH 5M in water with 10 wt % NaCl | 0.67 | kg |
| NaCl | 0.42 | kg |
| IPA | 1.40 | kg |
| Production Duration | 12 | hours |
| Desired Precursor Output | 0.16 | kg |

| | |
|---|---|
| Offloads (Automated in the Case of Propofol DIHA) | 1 |
| Description of Measured Purity/Quality | 87% |
| | LCAP |

TABLE 2
Productivity Performance

PoD v1.0 Performance

| Precursor | Productivity | Productivity Ratio |
|---|---|---|
| Propofol DIHA | 0.0133 kg/hour | 98.9 kg of Input/kg of Output |

### Example 9. Kit System Configurations and Reconfigurations

Precursors for ciprofloxacin, cisatracurium and midazolam have common acid chloride motifs. Using this common feature, the programming, configuration and reconfiguration of acid chloride-PFR modules was performed in Examples 10-14 where acid chlorides are formed for ciprofloxacin, cisatracurium and midazolam precursors. The acid chlorides are then combined with different modules to realize different outcomes—illustrating the reconfiguration. It was found that oxalyl chloride with DMF as a catalyst provided a fast and clean route to each of the acid chlorides. Multiple strategies were investigated to mitigate downstream challenges associated with residual oxalyl chloride in the products. Two different exemplary approaches are highlighted here: (1) use about 1 eq of oxalyl chloride or (2) use an evaporator to remove excess oxalyl chloride.

Acid chlorides are unstable species that can react with ambient water. This reactivity makes direct assays challenging. Accordingly, an assay was developed whereby acid chlorides and residual oxalyl chloride are reacted with excess ethanol to exhaustively esterify. The ester concentrations are then measured using gas or liquid chromatography. Gas chromatography with an FID detector can identify the ester at about 0.4 mg/mL. This approach was used to assay the performance of the acid chloride forming step and for remaining oxalyl chloride. These assays were also used for reaction optimization and evaluation of evaporation efficiency. The reaction was also monitored by GC/LC assays and NMR.

### Example 10. Ciprofloxacin Precursor Kit Configuration

In accordance with one or more aspects, the present invention provides a kit to produce 2,4,5-trifluorobenzoyl chloride (TBC) according to the following reaction.

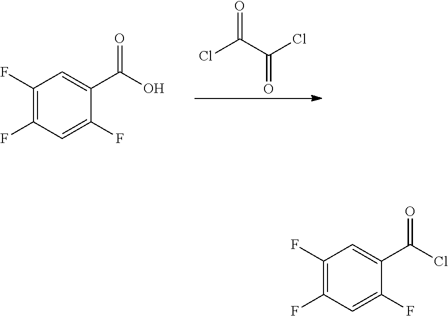 [SMILES: O=C(O)c1cc(F)c(F)cc1F ; O=C(Cl)C(=O)Cl ; O=C(Cl)c1cc(F)c(F)cc1F]

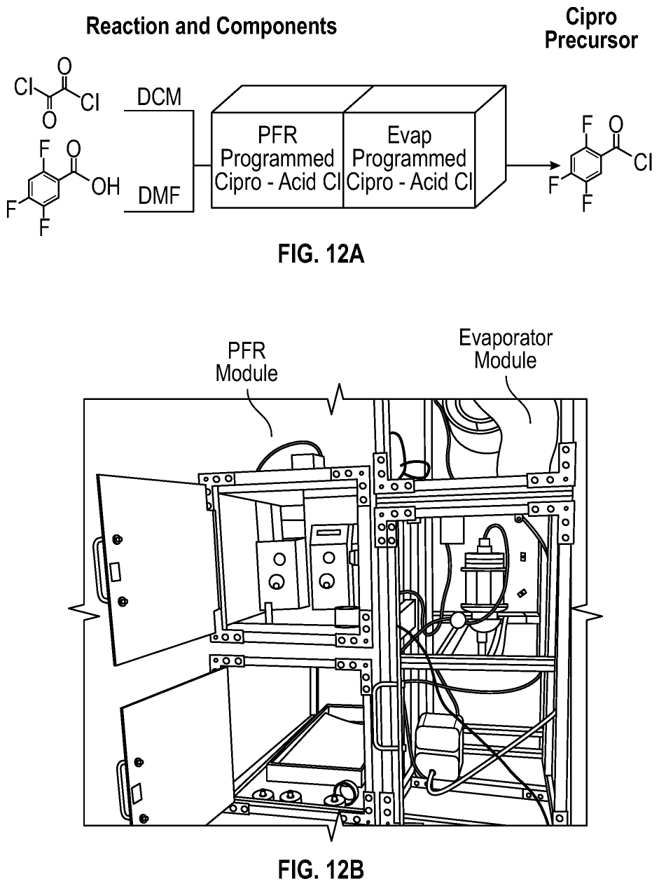

The reaction/kit sequence, a picture of the one aspect of the kit system, and data regarding the production of TBC are shown in FIGS. 12A and 12B. Two pumps deliver an oxalyl chloride solution and a 2,4,5-trifluorobenzoic acid solution into a t-mixer. Once combined, the mixture enters a plug-flow reactor module controlled by one of the two controllers attached to the frame in the upper right-hand corner. Within the plug-flow reactor module, oxalyl chloride dehydrates/chlorinates the benzoic acid resulting in the desired TBC. The product stream is then delivered to the evaporator module through a nozzle that also delivers dry nitrogen. The nozzle aspirates the product stream into the heated evaporator and the solvent exits the top of the evaporator module and the product is collected from the bottom of the reactor. Additional exemplary conditions used are provided below:
Feed Stock Solutions: Oxalyl chloride 6M in CH₂Cl₂
   Trifluorobenzoic Acid 2M in CH₂Cl₂: DMF (9:1)
Ratio of Flow Rate: Oxalyl Chloride to Trifluorobenzoic acid (1:1)
PFR Condition: 45 mL, 105° C., 150 psig, 5 min residence time
Evaporator Conditions: 100° C. (chamber surface temperature), 4 mL/min inlet flow rate, N₂ carrier gas 3 psig.
Daily Output (theoretical): 1.12 kg
Actual Daily Output: 0.57 kg, 57% recovered mass, 90% purity-22.5 min run

The NMR in FIG. 13 has a stack plot where the NMR shifts of the starting benzoic acid and the TBC product are compared. The acid chloride shifts the aromatic protons, and this data is consistent with reported values (Sigma-Aldrich reference spectra). The ratio of the DCM peak at 5.5 ppm and the aromatic protons of the product indicates a 4:1 product to DCM ratio. If the DCM is not tolerated (previous efforts have demonstrated chloroform to be an effective solution for the first half of the process), a solvent swap to remove the DCM.

TABLE 3
Ciprofloxacin Acid Chloride Precursor Production Measures

| Production Measure | Results | |
|---|---|---|
| Starting Materials Consumed | 0.411 | kg |
| Oxalyl Chloride (5.2M in DCM Dichloromethane) | 0.190 | kg |
| Fluoro (2.6M in DCM:DMF (76:24, v:v)) | 0.221 | kg |
| Production Duration | 180 | minutes |
| Desired Precursor Output | 0.072 | kg |

| | |
|---|---|
| Offloads (Manual in the Case of | 3 |
| Ciprofloxacin Acid Chloride) | |
| Description of Measured Purity/Quality | 90% by NMR |

TABLE 4
Ciprofloxacin Acid Chloride Precursor Productivity Performance

PoD v1.0 Performance

| Precursor | Productivity | Productivity Ratio |
|---|---|---|
| Ciprofloxacin | 0.024 kg/hour | 5.7 kg of Input/kg of Output |

### Example 11. Cisatracurium Precursor Module Performance

Cisatracurium requires a multi-step synthetic sequence. The complexity of the sequence provides a number of stable intermediates that might have intermittent availability. The reaction for the production of the amide intermediate to cisatracurium is shown below.

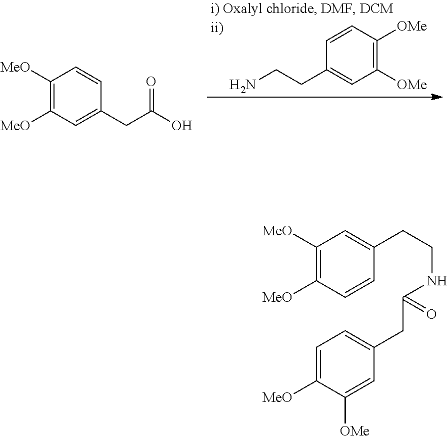 [SMILES: COc1ccc(CC(=O)O)cc1OC ; COc1ccc(CCN)cc1OC ; COc1ccc(CCNC(=O)Cc2ccc(OC)c(OC)c2)cc1OC]

The starting materials 3,4-dimethoxylphenylacetic acid and homoveratylamine are combined after the 3,4-dimethoxyphenylacetic acid is converted to the acid chloride. The amide product precipitates from solution and is collected in a filter-washer, washed first with pentane and then water.

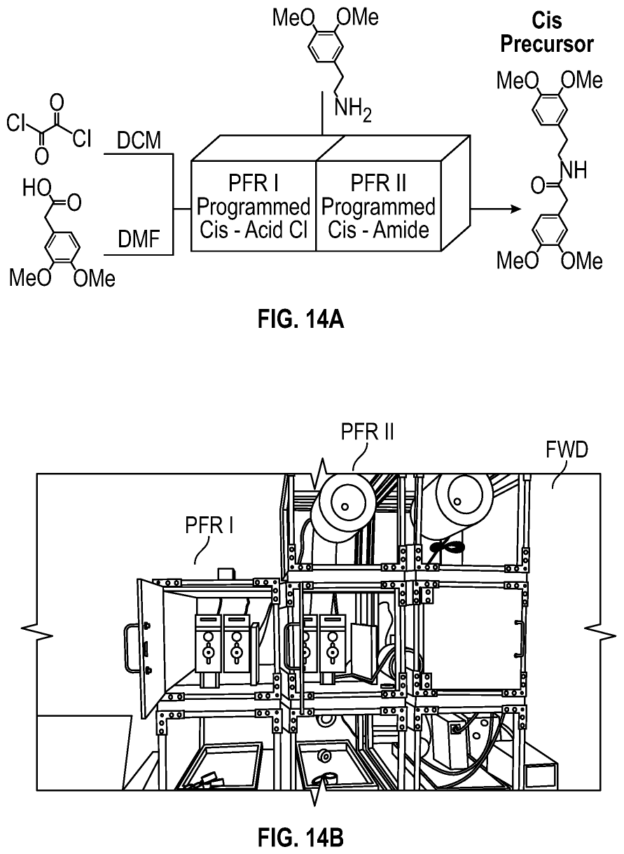

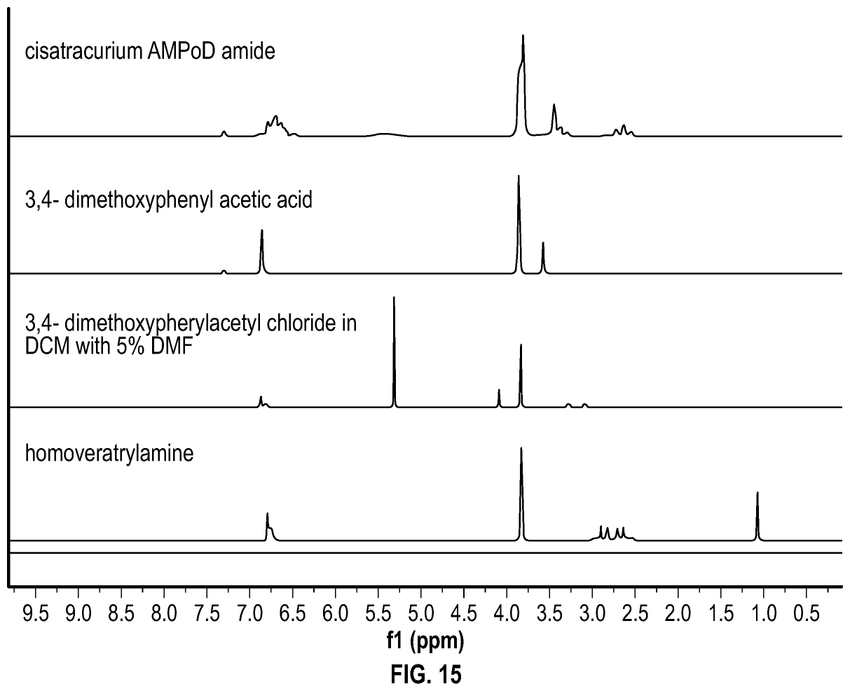

This reaction also features formation of an acid chloride. This segment demonstrates that the same PFR module could be programmed to work as the starting module for the cisatracurium process. FIG. 14A provides a summary of the cistatracurium-amide kit. The upper left-hand corner illustrates that the acid chloride module is now combined with a second PFR module where addition of homoveratylamine reacts to form the amide. FIG. 14B shows a picture of the two modules of the kit system. This system was run in both unprogrammed and programmed mode. The performance for both cases was coincident, indicating that the automated system performs as well as the human-centric system. The NMR stack-plot (FIG. 15) shows each starting material and the acid chloride intermediate and the final product emerging from the device. The reaction details are provided below and show a theoretical yield (1.86 kg/day). The yield was 37%.

An additional partial production run with automation of the first unit operation, a PFR module to determine if automation resulted in equivalent results. The outcome of the subsequent production for the first unit operation module under automation ran nearly identical in performance to the primary production run. The purity of the produced precursor was measured using LCAP (liquid chromatography area percent (LCAP) to be between 81-85% pure. The remaining percentages are starting material which remained in the production outputs. Basic measures of cisatracurium amide production performance are provided below.
Feed Stock Solutions: Oxalyl chloride 6M in CH₂Cl₂
   3,4-dimethoxyphenylacetic acid 1.6 M in CH₂Cl₂: DMF (19:1)
   Homoveratrylamine 1.2M+2 equivalents of Hunig Base+5% DMAP in CH₂Cl₂
Ratio of Flow Rates PFR1: Oxalyl Chloride to 3,4-dimethoxyphenylacetic acid (1:1)
Ratio of Flow Rates PFR2: Acid Chloride to Homoveratrylamine (1:1)
PFR1 Condition: 30 mL, 25° C., 150 psig, 5 min residence time
PFR2 Condition: 60 mL, 30° C., 50 psig, 10 min residence time

TABLE 5
Cisatracurium Amide Precursor Production Measures

| Production Measure | Results |
|---|---|
| Starting Materials Consumed | 2.469 kg |
| 1.6M solution of 3,4-dimethoxyphenylacetic acid (DMPA) | 0.829 kg |
| prepared in dichloromethane with 5% v:v dimethylformamide | |
| 6M solution of oxalyl chloride prepared in DCM | 0.263 kg |
| 1.2M homoveratrylamine, 2.4M Hunig's base, 0.06M | 0.683 kg |
| dimethylaminopyridine (DMAP) | |
| Pentane wash | 0.694 kg |
| Production Duration | 4 hrs 28 |
| | Min |
| Offloads (Manual in the Case of Cisatracurium Amide) | 3 |
| Desired Precursor Output | 0.094 kg |
| Description of Measured Purity/Quality | 81-85% |
| | LCAP |

TABLE 6
Cisatracurium Amide Precursor Productivity Performance

| | Performance | |
|---|---|---|
| Precursor | Productivity | Productivity Ratio |
| Cisatracurium | 0.021 kg/hour | 117.3 kg of Input/kg of Output |

### Example 12. Midazolam Precursor Kit Configuration

The Midazolam amide was prepared according to the following reactions.

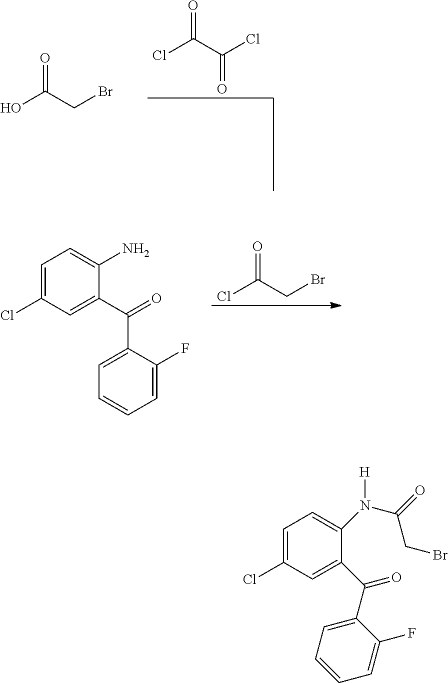 [SMILES: O=C(O)CBr ; O=C(Cl)C(=O)Cl ; Nc1ccc(Cl)cc1C(=O)c1ccccc1F ; O=C(Cl)CBr ; O=C(CBr)Nc1ccc(Cl)cc1C(=O)c1ccccc1F]

The benzophenone is acylated using bromoacetyl chloride followed by cyclization in the presence of ammonium hydroxide to yield the Midaz lactam precursor. FIG. 16A shows the reaction modules for the kit (upper panel), and the assembled kit (lower panel). FIG. 16B shows the midazolam-amide kit. The middle level on the image shows the two Eldex metering pumps, a back-pressure regulator (gold) and a PFR slotted in an alternative sideways orientation. The same image shows the reactive-FWD along with a Tacmina metering pump.

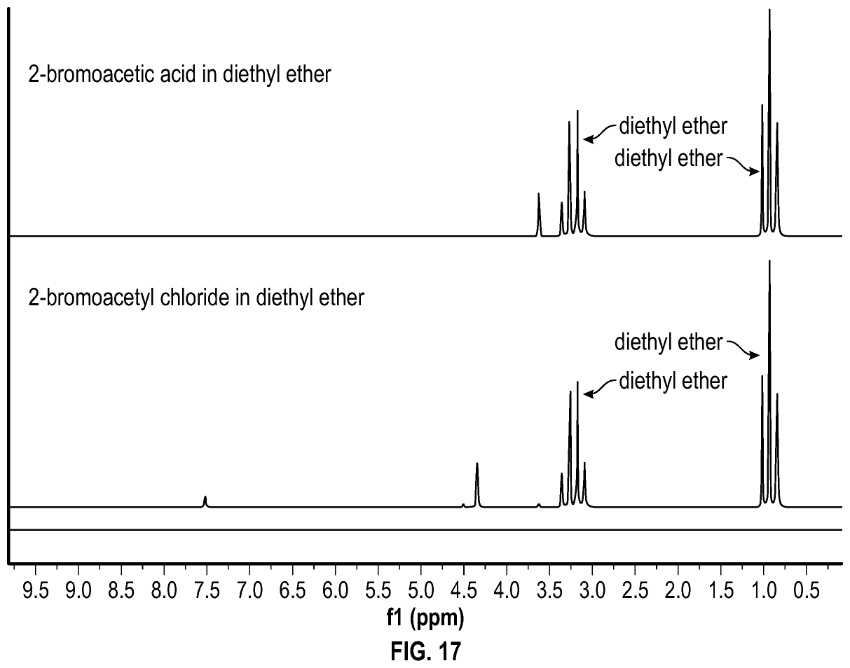

The NMR data showing the formation of the acid chloride and the reaction conditions and potential system throughput is provided in FIG. 17. The system was run for 11 hours in an unprogrammed format to collect set-points. The reaction conditions and throughput are provided below.

The midazolam amide production was run twice—once in a manual production configuration for 11 hours and again in an automated configuration environment for 1 hour where the first unit operation was automated

The experiment demonstrated the ability to reconfigure the cisatracurium amide precursor module to produce the midazolam amide precursor module. This reconfiguration occurred on the scale of minutes, demonstrating an important capability of the same system components to produce multiple precursors by changing set points and in some cases components.

TABLE 7
Midazolam Amide Precursor Production Measures
(Run 1 - Manual; Run 2 - Limited Automation)

| | Results | | Results | |
|---|---|---|---|---|
| Production Measure | (Run 1) | | (Run 2) | |
| Starting Materials Consumed | 4.295 | kg | 0.761 | kg |
| Oxalyl Chloride in solution | 0.424 | kg | 0.119 | kg |
| with Diethyl Ether | | | | |
| Bromoacetic Acid in solution | 0.492 | kg | 0.138 | kg |
| with Diethyl Ether | | | | |
| Benzophenone dissolved | 0.566 | kg | 0.084 | kg |
| in Diethyl Ether | | | | |
| NaHCO₃ | 2.1 | kg | 0.42 | kg |
| Diethyl Ether | 0.713 | kg | 0.143 | kg |
| Production Duration | 11 | hours | 72 | minutes |
| Desired Precursor Output | 0.1419 | kg | 0.026 | kg |

| | | |
|---|---|---|
| Offloads (Manual in the Case of | 10 | 2 |
| Midazolam Amide) | | |
| Description of Measured | 87% | 91% |
| Purity/Quality | LCAP | LCAP |

TABLE 8
Midazolam Amide Precursor Productivity Performance

Performance

| Precursor | Productivity | Productivity Ratio |
|---|---|---|
| Midazolam | 0.013 kg/hour | 30.3 kg of Input/kg of Output |
| Amide (run 1) | | |
| Midazolam | 0.022 kg/hour | 29.3 kg of Input/kg of Output |
| Amide (run 2) | | |

TABLE 9
Midazolam Lactam Precursor Production Measures

| Production Measure | Results | |
|---|---|---|
| Starting Materials Consumed | 0.100 | kg |
| 2-Bromo-N-[4-chloro-2- | 0.081 | kg |
| (2-fluorobenzoyl)phenyl]acetamide | | |
| Ammonium Hydroxide | 0.019 | kg |
| Production Duration | 90 | minutes |
| Desired Precursor Output | 0.0026 | kg |

| | |
|---|---|
| Offloads (Manual in the Case | 1 |
| of Midazolam Lactam) | solution |
| Description of Measured Purity/Quality | 69% |
| | LCAP |

### Example 13. Cisatracurium Amide Kit Reprogramming Into Midazolam Amide System and Back

This experiment demonstrated switching the same PFR module back and forth between cisatracurium amide and midazolam amide programs by changing the programming sequence.

The cisatracurium amide kit consists of an acid chloride producing PFR module and second PFR module to perform an amide forming step by reacting the acid chloride with an amine. We programmed the acid chloride production module and switched the program between parameterization for running the cisatracurium amide and midazolam amide process. The midazolam-amide process was run, and the liquid-chromatography area percent (LCAP) indicates that the quality of the program-produced product is high quality (87 vs. 90% LCAP). The same kit was reprogrammed to perform the cisatracurium amide process. Switching back and forth was accomplished in under an hour.

### Example 14. Systems and Methods for Contactless Detection of Chemicals in a Container

Experimental Setup:
   Spectrometers:
   HDX-XR (UV-VIS-NIR)
   FlameNIR (NIR)
   HDX-Raman (785 nm)
   Light Source:
   DH-2000-BAL (UV-VIS-NIR)
   HL-2000 (VIS-NIR)
   LASER-785-LAB-ADJ-SMA (785 nm laser)
Fiber and Sampling Accessories:
   74-ACH (adjustable collimating lens holder)
   QR600-7-SR (UV-VIS probe)
   QR400-7-VIS-NIR (VIS-NIR probe)
   RIP-RPB-785 (Raman probe)
   QP600-025-XSR (UV-VIS patch fiber)
   QP600-025-VIS-NIR (VIS-NIR patch fiber)
   RPH-1 (90°/45° reflection probe holder)
   WS-1 (white reflection standard)
Samples in IV bags:
   DI Water
   Propofol Drug Product
   Propofol Placebo
   Cisatracurium Drug Product
   Cisatracurium Placebo

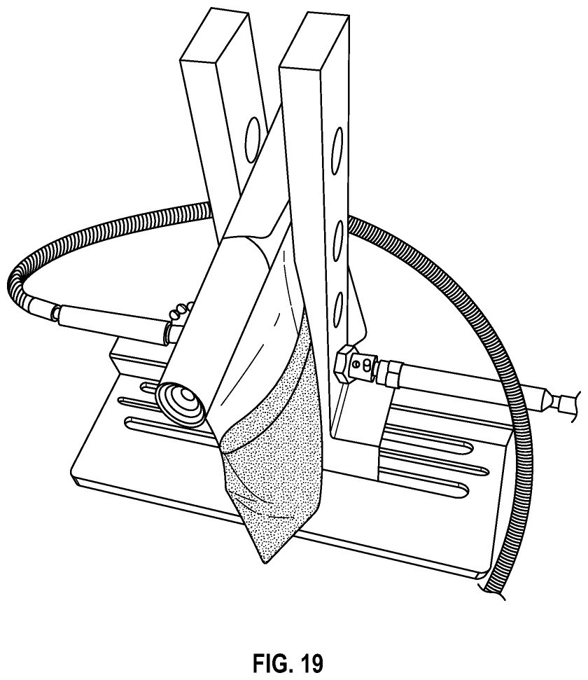

Broadband spectroscopy was used to interrogate all samples in the appropriate mode, whether transmissive or reflective. The samples of water, cisatracurium, and the respective placebo were all able to be measured by transmission through the IV bag and fluid as shown in FIG. 19.

The method depicted in FIG. 19 used a 74-ACH adjustable collimating lens holder to route the light through a consistent pathlength for the IV bags to sit within. Scans were performed with the HDX-XR spectrometer for UV-VIS measurements and the FlameNIR for the NIR region.

The propofol drug product and respective placebo were each too optically opaque to allow for transmission measurements. Due to the opacity of the fluid contents, the propofol IV bags simply looked like ‘dark’ reference scans when measured in transmission mode. These samples were interrogated in reflective mode with the RPH-1 90°/45° reflection probe holder held against the IV bag as shown in FIG. 20. A white reflection standard was used to create the reference condition for these samples. The appropriate reflection probes were used for two optical ranges (UV-vis and NIR) and used the HDX-XR and FlameNIR spectrometers, respectively. The RPH-1 reflection probe holder was used to run a brief distance and angle study with the probe held at 90° and 45° at several distances from the sample.

Raman scans were all performed using the 785 nm Raman probe held at 90° flush-against the sample bags, as is standard for this type of Raman sampling and specific probe.

### Transmission of Cisatracurium Fluids

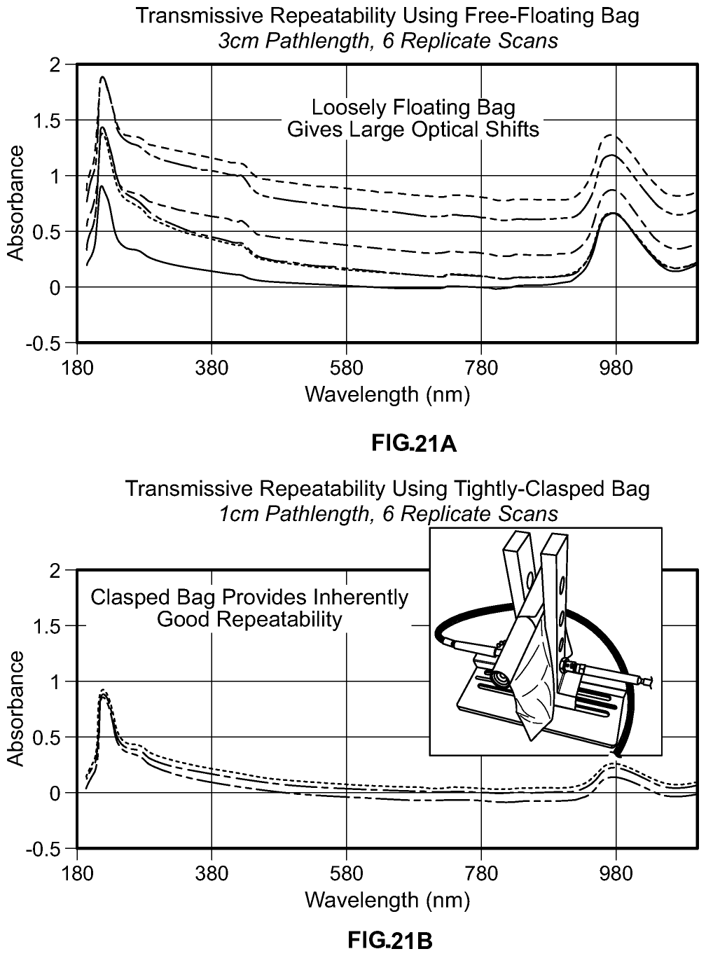

Transmissive Pathlength. Two approaches were evaluated for the transmission measurements, including a wide gap, such that the bag could freely float within the space (3 cm), and also a tight gap, which firmly clasped each side of the bag (1 cm). The free-floating scenario (FIG. 21A) had more variation, while the clasping scenario (FIG. 21B) showed strong repeatability. In some aspects a clasping handheld tool (such as a pair of ‘optical pliers’) can provide for quick, repeatable measurements of the transmissive fluids in IV bag style containers.

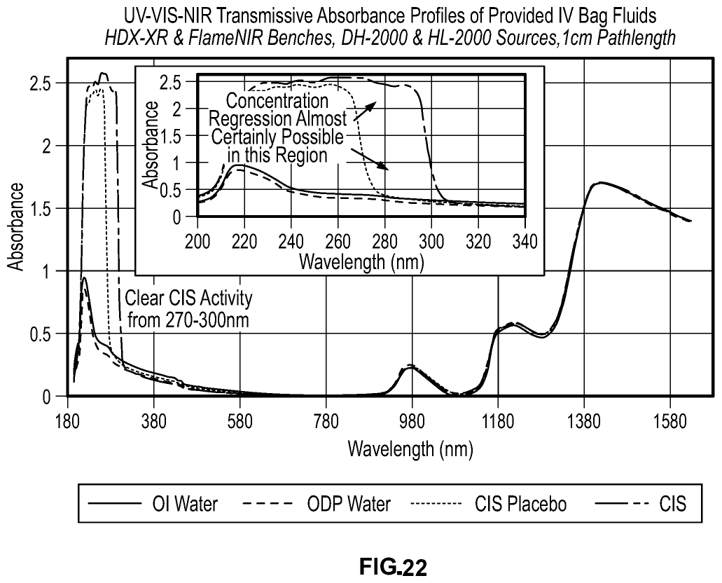

Broadband Cisatracurium Activity. FIG. 22 shows a spliced plot from both the HDX-XR and FlameNIR spectrometers to show the total fluid activities from 200 nm to 1600 nm. All trends use air as the light reference. The zoomed-in plot of the UV region highlights the unique activity of the CIS-placebo versus water, and also the CIS-drug versus placebo. The 270-300 nm band shows activity unique to the CIS-drug, and there is enough bandwidth there to allow the performance of concentration analysis.

With 2 AU of usable absorbance delta, and assuming the provided drug product was at 100% strength, the system should resolve to 0.5% of the total concentration range.

Due to the opacity of the propofol samples, the NIR range showed no usable differentiation between samples, and the propofol samples essentially blocked all light and registered as a dark scan.

Reflection of Propofol Fluids. The propofol samples were very white and optically opaque in nature, thus needing a reflective mode to interrogate. As mentioned, a white reflection standard was used as the light reference in all scenarios, and these tests were performed at 90° and 45° at several distances.

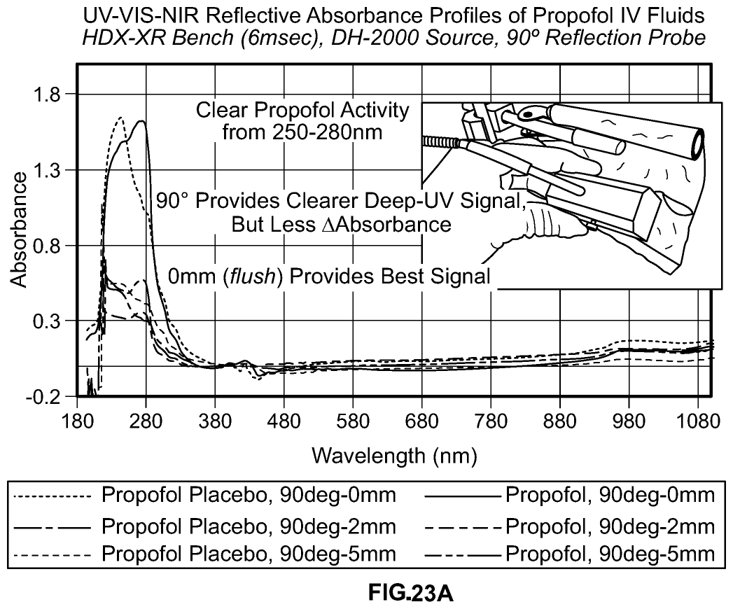

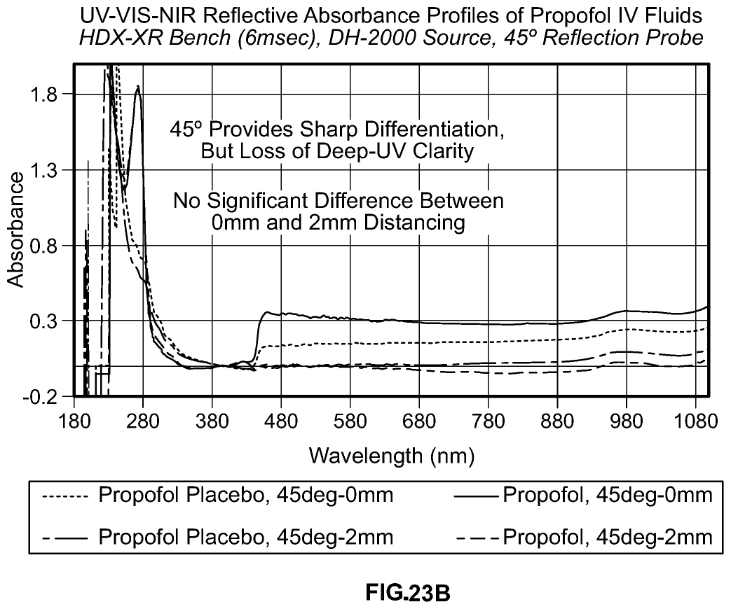

The plots shown in FIGS. 23A and 23B summarize the results of the UV-VIS scans with the 90° trends (FIG. 23A) and 45° trends (FIG. 23B). In the 90° scenario, the 0 mm ‘flush’ distance provided the best signal, and this direct angle also gave a clearer view of the lowest wavelengths. However, the 45° scenario lost a bit of the clarity of the lower wavelengths but provides a larger and sharper absorbance difference between drug-free and drug-containing solutions. Distancing at 45° did not have much of an observable effect. The data show that there is clear usable activity in the UV region for the propofol drug product, which would provide the capability for concentration regression.

As with cisatracurium, the propofol results showed no significant differences in the NIR wavelength region.

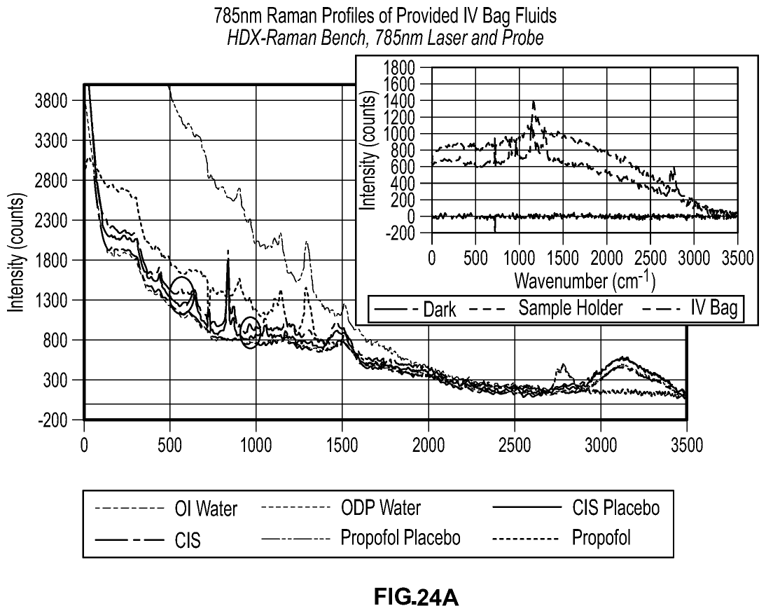

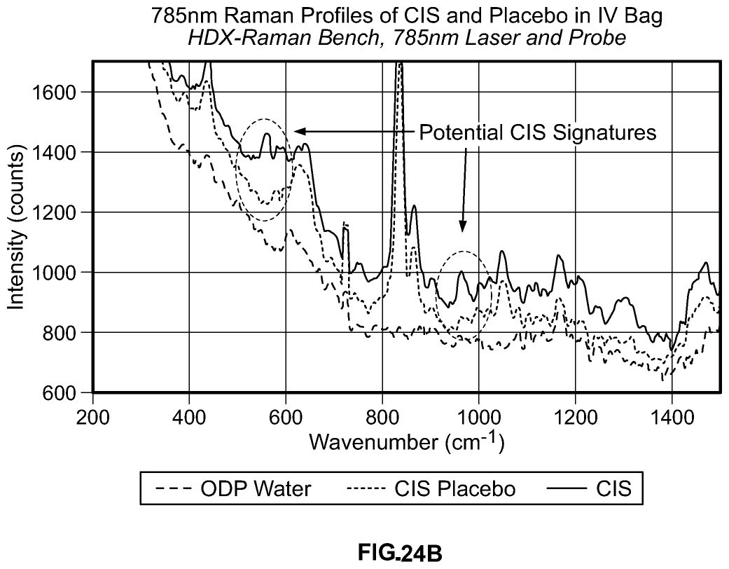

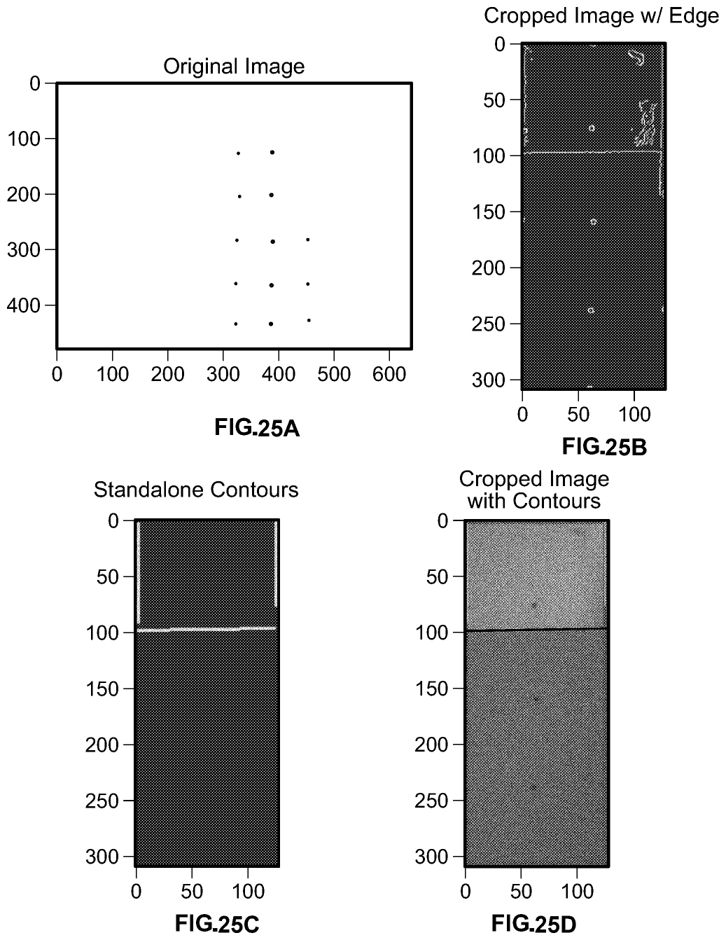

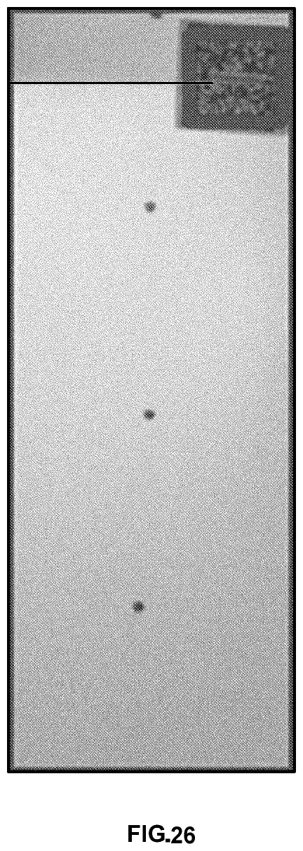

785 nm Raman Testing. The final technique investigated was 785 nm Raman spectroscopy through the wall of the IV bags. Results are summarized in the plots shown in FIGS. 24A and 24B, with an inlaid plot of FIG. 24A for the dark condition, sample holder, and empty IV bag, to show those activities versus the more primary analytes.

The majority of the peaks observed from the cisatracurium and propofol samples are unique from one another, but largely persist between the placebo and active drug product. This suggests we are detecting the other inert buffer components in the bulk fluid. This is useful for general spectroscopic ‘fingerprint identification’ of unknown fluids in the field (i.e., two IV bags with ‘clear’ liquid but different drugs/purposes).

While the propofol scans did not show much optical coherence nor differentiation between the placebo and active drug product, there were a few cisatracurium activities that are indicative of that drug product, indicated by the circled portions in the plots of FIG. 24A and 24B. These peaks can be used as identifiers to confirm the desired drug product is present, though could not provide concentration values as the UV/VIS scans could.

For both drug products, the most successful detection and quantification approach came from UV absorbance activities in the 250-300 nm region. Transmissive fluids such as the cisatracurium samples are best interrogated in transmissive mode using a fixed pathlength that holds the bag firmly and repeatedly. Opaque fluids such as the propofol samples are best interrogated in reflective mode using a reflection probe at 45°. Preliminary calculations estimate there is potential to resolve down to 0.5% of the total concentration using these approaches.

The Raman spectroscopy provided unique peaks for the bulk fluid used, which can be useful in differentiating between the total IV bag components for different drug products.

### Example 15. Volume Detection

The detection system of the instant disclosure provides real time fluid volume with ˜15 mL granularity. The detection system also provides real time flow rate measurements as an extra step to validate pump output.

Using a 4th generation raspberry pi with 4GB of RAM and a Pi NoIR V2 camera with open-source computer vision modules, OpenCV, generated algorithms using python programming language are called from the terminal. Users are prompted with adjusting the region of interest prior to computation. In real-time, meniscus of fluids are determined and updated in a CSV file at a frequency defined by the user. Flow is calculated by taking the absolute value of the difference in volume at time x and x+1 and dividing by total time in-between. When the module is closed, the updated CSV file is saved to the users' directory.

Water was used as a test case in a translucent HDPE container to test this system. Tubing was connected to the container through the lid and liquid was pumped out for use in the DIHA synthesis platform. The remaining amount of liquid and its rate of transfer was measured and compared with values recorded from other instruments to show the accuracy of this system.

This method of volume measurement is based on computer vision and it can work with liquids, solids, as well as homogeneous and non-homogeneous mixtures of the two.

### Example 16. Determining API Sequence Based on Reactant QR Codes

Within the product-on-demand systems, QR codes are detected using either a 4th generation raspberry pi with 4 GB of RAM and a Pi NoIR V2 camera coincided with open-source computer vision modules, OpenCV. QR codes are generated using open-source packages such as PyZBar. Final formulated containers or starting materials containers contain generated QR codes with chemical names embedded as strings. QR codes are read and further applications/sequences are determined based on the information read.

Labeling the containers using QR code, bar code, RFID, or similar technologies allows automated tracking of raw material, intermediates, and processes in a PoD system. It also reduces operator error by providing a means for the product-on-demand system to match the material with the selected process. FIG. 28 shows an aspect of the system for detection and monitoring of the liquid level in a rigid container using a QR-code obstructing the cropped image view.

### Example 17

A product-on-demand system comprises multiple containers for starting materials, optionally containers for intermediates, and one or more containers for products. Several unit operations exist in between that can be in the shape of containers, including reactors, such as tube reactors, CSTRs or FWDs, and tubing (PFR), vessels for separation, crystallization and/or filtration. Each of the units are connected is sequence using a fluidic path. Studying the process of the product-on-demand system determines Critical Quality Attributes (CQA) of the system, which are monitored for ensuring the quality of the product. The system described herein can be set on any vessel or fluidic path to monitor the CQA of the system for making a quality product. This can be at any step of the synthesis, purification, or formulation to monitor and control the starting material, intermediates, or final products.

What is claimed is:

1. A unit operation module for use in a modular kit system for manufacturing a chemical composition, the unit operation module comprising:
a. a chassis;
b. a unit operation module controller affixed in the chassis, wherein the unit operation module controller is operable to control a unit operation performed by the unit operation module in a process of manufacturing a chemical composition and wherein the unit operation controller is operable to receive sensor data and communicate with one or more controllers;
c. a unit operation component affixed in the chassis, wherein the unit operation component is selected from the group consisting of reactors, separators, filter washer dryers, crystallizers, sterilizers, formulators, evaporators, and any combination thereof;
d. one or more fluidic connections operable to fluidically connect two or more unit operation modules; and
e. one or more ancillary component selected from vessels, temperature control devices, mixers, valves, sensors, pumps, power supplies, and any combination thereof
wherein the unit operation module is operable to be configured to perform the unit operation in the process of manufacturing the chemical composition.

2. The unit operation module of claim 1, wherein the unit operation component is a reactor.

3. The unit operation module of claim 2, wherein the reactor is a plug flow reactor (PFR), a stirred tank reactor (STR), or a continuously stirred tank reactor (CSTR).

4. The unit operation module of claim 2, wherein the plug flow reactor module comprises a PFR and further comprises a power supply, a temperature control device, one or more diverter valves fluidically connected to the one or more fluidic connections, one or more pumps, a backpressure regulator, two or more vessels, and one or more mixers.

5. The unit operation module of claim 2, wherein the unit operation module is a stirred tank reactor module and the stirred tank reactor module comprises a STR and/or a CSTR and further comprises a power supply, a temperature control device, one or more diverter valves fluidically connected to the one or more fluidic connections, one or more pumps, a backpressure regulator, two or more vessels, and one or more mixers.

6. The unit operation module of claim 1, wherein the unit operation module is a separator module and the separator module comprises a gravity separator, a filter washer dryer (FWD), a column, or any combination thereof and further comprises a power supply, one or more diverter valves fluidically connected to the one or more fluidic connections, one or more pumps, a separator, two or more vessels, and one or more mixers.

7. The unit operation module of claim 1, wherein the unit operation module comprises a membrane separator and further comprises a power supply, one or more diverter valves fluidically connected to the one or more fluidic connections, one or more pumps, a membrane separator, two or more vessels, and one or more mixers.

8. The unit operation module of claim 1, wherein the unit operation module is a separator module and the separator module comprises a filter washer dryer (FWD) and further comprises a power supply, one or more diverter valves fluidically connected to the one or more fluidic connections, one or more pumps, two or more vessels, and one or more mixers.

9. The unit operation module of claim 1, wherein the unit operation module comprises an evaporator and further comprises a power supply, at least one gas inlet and outlet, a heating element, a thermocouple, one or more diverter valves fluidically connected to the one or more fluidic connections, one or more pumps, a pressure regulator, an evaporation unit, and two or more vessels.

10. The unit operation module of claim 1, wherein the unit operation module controller acts as input/output boards relaying instructions out to the unit operation component and ancillary components and receiving information from the unit operation component and ancillary components.

11. A modular kit system for use in manufacturing chemical compositions, the modular kit system comprising:
a. two or more fluidically connected unit operation modules each configured to perform a unit operation in chemical synthesis processes, wherein each unit operation module comprises:
i. a chassis;
ii. a unit operation module controller affixed in the chassis, wherein the unit operation module controller is operable to control a unit operation performed by the unit operation module in a process of manufacturing a chemical composition and wherein the unit operation controller is operable to receive sensor data and communicate with one or more controllers;
iii. a unit operation component affixed in the chassis, wherein the unit operation component is selected from the group consisting of reactors, separators, filter washer dryers, crystallizers, formulators, evaporators, and any combination thereof;
iv. one or more fluidic connections operable to fluidically connect two or more unit operation modules; and
v. one or more ancillary components selected from vessels, temperature control devices, mixers, valves, sensors, pumps, power supplies, and any combination thereof; and
b. a kit system master controller in electronic communication with each unit operation module controller, wherein the master system controller is operable to be programmed to execute a chemical synthesis process for manufacturing a chemical composition of interest;
wherein providing the modular kit system with precursors and reagents and activation of the modular kit system synthesizes the chemical composition of interest.

12. The system of claim 12, wherein the modular kit system comprises a reactor module, a separator module, a crystallizer module, and a filter washer dryer module.

13. The system according to any one of claims 13, wherein the reactor module comprises a reactor selected from the group consisting of a plug flow reactor (PFR), a stirred tank reactor (STR), and a continuously stirred tank reactor (CSTR).

14. The system according to any one of claim 13, wherein the reactor module comprises a PFR and the reactor module further comprises a power supply, a temperature controller, one or more diverter valves fluidically connected to the one or more fluidic connections, a heating element, one or more pumps, a backpressure regulator, two or more vessels, and one or more mixers.

15. The system according to any one of claim 13, wherein the reactor module comprises a STR or a CSTR and the reactor module further comprises a power supply, a temperature controller, one or more diverter valves fluidically connected to the one or more fluidic connections, a heating element, one or more pumps, a backpressure regulator, two or more vessels, and one or more mixers.

16. The system according to any one of claim 13, wherein the separator module comprises a membrane separator and further comprises a power supply, one or more diverter valves fluidically connected to the one or more fluidic connections, one or more pumps, a membrane separator, two or more vessels, and one or more mixers.

17. A programmed kit system (pharmacy on demand; “PoD”) unit to produce and provide pharmaceutical precursor molecules, and/or active pharmaceutical ingredients (API) and/or finished pharmaceuticals directly to one or more subjects in need thereof, within minutes to weeks of manufacturing, the PoD unit comprising:
a. two or more fluidically connected unit operation modules each configured to perform a unit operation in chemical synthesis processes of the PoD, wherein each unit operation module comprises:
i. a chassis;
a unit operation module controller affixed in the chassis, wherein the unit operation module controller is operable to control a unit operation performed by the unit operation module in a process of manufacturing a chemical composition and wherein the unit operation controller is operable to receive sensor data and communicate with one or more controllers;
iii. a unit operation component affixed in the chassis, wherein the unit operation component is selected from the group consisting of reactors, separators, filter washer dryers, crystallizers, formulators, evaporators, and any combination thereof;
iv. one or more fluidic connections operable to fluidically connect two or more unit operation modules; and
v. one or more ancillary components selected from vessels, temperature control devices, mixers, valves, sensors, pumps, power supplies, and any combination thereof; and
b. a kit system master controller in electronic communication with each unit operation module controller, wherein the master system controller is programmed to execute a chemical synthesis process for manufacturing a chemical composition of interest;
wherein providing the PoD with precursors and reagents and activation of the modular kit system synthesizes the chemical composition of interest.

18. A method for making a chemical composition using the system of any one of the preceding claims, the method comprising:
a. determining the number and type of unit operation modules necessary to synthesize a chemical composition of interest;
b. fluidically and electronically connecting the unit operation modules of a) to each other in a predetermined sequence identified in a);
c. programming the kit system master controller to execute the chemical synthesis process of the chemical composition of interest using the one or more of the unit operation module kits of a);
d. adding all of the reagents and precursors to the vessels of the unit operation module kit as determined in step a); and
e. activating the system to prepare the chemical composition of interest.
